(19) United States
(12) Patent Application Publication
(10) Pub. No.: US 2025/0260889 A1
(43) Pub. Date: Aug. 14, 2025

(54) DISPLAY APPARATUS AND PROCESSING METHOD FOR DISPLAY APPARATUS

(71) Applicant: HISENSE VISUAL TECHNOLOGY CO., LTD., Qingdao (CN)

(72) Inventors: Xiaoming SHAO, Qingdao (CN); Guili JIA, Qingdao (CN); Yanqing RU, Qingdao (CN)

(21) Appl. No.: 19/192,162

(22) Filed: Apr. 28, 2025

Related U.S. Application Data
(63) Continuation of application No. PCT/CN2023/112974, filed on Aug. 14, 2023.

(30) Foreign Application Priority Data
Dec. 2, 2022 (CN) 202211544807.2
Dec. 19, 2022 (CN) 202211635507.5
Dec. 28, 2022 (CN) 202211697408.X
Dec. 29, 2022 (CN) 202211711091.0
Jan. 9, 2023 (CN) 202310027361.4

(51) Int. Cl. H04N 23/611; H04N 23/62; H04N 23/71

(52) U.S. Cl. CPC H04N 23/611; H04N 23/62; H04N 23/71

(57) ABSTRACT

Disclosed are a display apparatus and a processing method for a display apparatus. The display apparatus includes: a memory, and at least one processor, in connection with the memory and configured to execute the computer instructions to enable the display apparatus to: monitor a camera status broadcast message sent from a camera service in an operating system, which camera status broadcast message is used for indicating whether a camera is activated by an application, based on that the camera status broadcast message is a camera release message, call the camera to capture a camera image, which camera release message is used for indicating that the camera is not activated by the application, obtain human feature data from the camera image, and according to a control instruction corresponding to the human feature data, control the display apparatus to execute a corresponding function.

### CROSS REFERENCES TO RELATED APPLICATIONS

This application is a continuation of International Application No. PCT/CN2023/112974, filed on Aug. 14, 2023, which claims priorities to Chinese Patent Application No. 202211544807.2, filed on Dec. 2, 2022, Chinese Patent Application No. 202211635507.5, filed on Dec. 19, 2022, Chinese Patent Application No. 202211697408.X, filed on Dec. 28, 2022, and Chinese Patent Application No. 202211711091.0, filed on Dec. 29, 2022, and Chinese Patent Application No. 202310027361.4, filed on Jan. 9, 2023, all of which are hereby incorporated by reference in their entireties.

### TECHNICAL FIELD

The present application relates to the technical field of display apparatuses, and in particular to a display apparatus and a processing method for the display apparatus.

### BACKGROUND

With the improvement of chip performance and the use of accelerated processing units (APUs) and graphics processing units (GPUs) in display apparatuses, the ability to perform image processing and deep learning operations on displays has been further improved. During image processing, the camera is managed uniformly by the operating system of the display apparatus, and only one application can use the camera at the same time. At present, in order to ensure that the artificial intelligence (AI) algorithm that needs to use the camera in all scenarios calls the camera, the related technology will terminate the process of other applications using the camera and dispatch the camera resources to the AI algorithm for use. This affects the use of the camera by other applications and easily leads to confusion in camera resource management.

### SUMMARY

A display apparatus according to embodiments of the present application includes: a memory, configured to store computer instructions and/or data associated with the display apparatus; at least one processor, connected with the memory, where the at least one processor is configured to execute the computer instructions to enable the display apparatus to: monitor a camera status broadcast message sent from a camera service in an operating system, where the camera status broadcast message is used to indicate whether a camera is activated by an application; based on that the camera status broadcast message is a camera release message, call the camera to capture a camera image through a global application of the display apparatus, where the camera release message is used to indicate that the camera is not activated by the application; obtain human feature data from the camera image, and control the display apparatus to execute a corresponding function according to a control instruction corresponding to the human feature data.

A processing method for a display apparatus according to embodiments of the present application, includes: monitoring a camera status broadcast message sent from a camera service in an operating system, where the camera status broadcast message is used to indicate whether a camera is activated by an application; based on that the camera status broadcast message is a camera release message, calling the camera to capture a camera image through a global application of the display apparatus, where the camera release message is used to indicate that the camera is not activated by the application; obtaining human feature data from the camera image, and controlling the display apparatus to execute a corresponding function according to a control instruction corresponding to the human feature data.

### BRIEF DESCRIPTION OF FIGURES

FIG. 1 is a schematic diagram of an operation scenario between a display apparatus and a control apparatus according to some embodiments of the present application.

FIG. 2 is a schematic diagram of an application scenario of a display apparatus according to some embodiments of the present application.

FIG. 3 is a configuration block diagram of a control device 100 according to some embodiments of the present application.

FIG. 4 is a hardware configuration block diagram of a display apparatus 200 according to some embodiments of the present application.

FIG. 5A is a schematic diagram of software configuration in a display apparatus 200 according to some embodiments of the present application.

FIG. 5B is a schematic diagram showing an icon control interface of an application in a display apparatus 200 according to one or more embodiments of the present application.

FIG. 6 is a first flowchart diagram of a processing method for a display apparatus according to some embodiments of the present application.

FIG. 7 is a schematic diagram of a user interface according to some embodiments of the present application.

FIG. 8 is a schematic diagram of a camera image according to some embodiments of the present application.

FIG. 9 is a second flow chart of a processing method for a display apparatus according to some embodiments of the present application.

FIG. 10 is a third flow chart of a processing method for a display apparatus according to some embodiments of the present application.

FIG. 11 is a schematic diagram of a horizontal detection area and a vertical detection area according to some embodiments of the present application.

FIG. 12 is a first flowchart diagram of another processing method for a display apparatus according to some embodiments of the present application.

FIG. 13 is a schematic diagram of a video page according to some embodiments of the present application.

FIG. 14 is a schematic diagram of a rectangular area of a human body contour according to some embodiments of the present application.

FIG. 15 is a schematic diagram of vertex coordinates of a preset effective control area according to some embodiments of the present application.

FIG. 16 is a first schematic diagram of a video page according to some embodiments of the present application.

FIG. 17 is a second schematic diagram of a video page according to some embodiments of the present application.

FIG. 18 is a schematic diagram of a process of calculating a first size of a human body portion that is not captured according to some embodiments of the present application.

FIG. 19 is a second flow chart of another processing method for a display apparatus according to some embodiments of the present application.

FIG. 20 is a schematic diagram of second prompt message according to some embodiments of the present application.

FIG. 21A is a schematic diagram of a scenario of switching channels using a gesture display apparatus according to some embodiments of the present application.

FIG. 21B is a schematic diagram of another scenario of switching channels using a gesture display apparatus according to some embodiments of the present application.

FIG. 22A is a framework diagram of a gesture setting system for a display apparatus according to one or more embodiments of the present application.

FIG. 22B is a diagram showing a gesture setting architecture of a display apparatus according to one or more embodiments of the present application.

FIG. 23A is a first flowchart diagram of a third processing method for a display apparatus according to some embodiments of the present application.

FIG. 23B is a schematic diagram of a scene of a gesture setting interface according to some embodiments of the present application.

FIG. 23C is a second flow chart of a third processing method for a display apparatus according to some embodiments of the present application.

FIG. 23D is a third flow chart of a third processing method for a display apparatus according to some embodiments of the present application.

FIG. 23E is a schematic diagram of another scene of a gesture setting interface according to some embodiments of the present application.

FIG. 23F is a schematic diagram of a scene of a user prompt interface according to some embodiments of the present application.

FIG. 23G is a fourth flowchart of a third processing method for a display apparatus according to some embodiments of the present application.

FIG. 23H is a schematic diagram of a scene of starting a gesture setting function interface according to some embodiments of the present application.

FIG. 23I is a fifth flowchart diagram of a third processing method for a display apparatus according to some embodiments of the present application.

FIG. 24 is a flowchart of a fourth processing method for a display apparatus according to some embodiments of the present application.

FIG. 25 is a schematic diagram of a preset gesture according to some embodiments of the present application.

FIG. 26 is a schematic diagram of a first gesture image according to some embodiments of the present application.

FIG. 27 is a schematic diagram of a second gesture image according to some embodiments of the present application.

FIG. 28 is a schematic diagram of determining a gesture movement direction and a gesture movement speed according to some embodiments of the present application.

FIG. 29 is a schematic diagram of a coordinate range to be recognized according to some embodiments of the present application.

FIG. 30 is a schematic diagram of a third gesture image according to some embodiments of the present application.

FIG. 31 is a flow chart of a processing method for a display apparatus in the related art.

FIG. 32 is a system framework diagram of a fifth processing method for a display apparatus according to one or more embodiments of the present application.

FIG. 33A is a first flowchart diagram of a fifth processing method for a display apparatus according to some embodiments of the present application.

FIG. 33B is a schematic diagram of an interface when a display shows prompt message according to some embodiments of the present application.

FIG. 34A is a second flow chart of a fifth processing method for a display apparatus according to some embodiments of the present application.

FIG. 34B is a schematic diagram of an interface when a display shows target information of resource management according to some embodiments of the present application.

FIG. 35 is a schematic diagram of an interaction process between modules for implementing a fifth processing method for a display apparatus according to some embodiments of the present application.

FIG. 36 is a schematic diagram of the interaction process between modules of another implementation of the fifth processing method for a display apparatus according to some embodiments of the present application.

### DETAILED DESCRIPTION

In order to more clearly understand the above-mentioned purposes, features and advantages of the present application, the scheme of the present application will be further described below. It should be noted that embodiments of the present application and the features in the embodiments can be combined with each other without conflict.

In the following description, many specific details are set forth to facilitate a full understanding of the present application, but the present application can also be implemented in other ways different from those described herein; obviously, embodiments in the specification are only part of the embodiments of the present application, rather than all of the embodiments.

At present, display apparatuses can use cameras to capture images, and use AI (Artificial Intelligence) algorithms to process images to determine corresponding control instructions, and control the display apparatuses to perform corresponding operations. For example, in a global control scenario, the display apparatus can meet the needs of user gesture control by detecting user gestures. The camera can automatically start after the display apparatus is turned on, but the camera is an exclusive resource and can only be used by one application at the same time. When other applications use the camera to take images or record videos, the AI algorithm's call to the camera can be preempted. In related technologies, in order to meet the AI algorithm's call to the camera, the use of the camera by other applications can be immediately terminated, thereby transferring the camera resources to the AI algorithm for use, which can affect the normal operation of other applications, and can cause each application to snatch camera resources, resulting in chaotic camera resource management, which in turn can affect the user's experience.

In order to solve the above problems, embodiments of the present application provide a display apparatus and a processing method for the display apparatus. The display apparatus can include a memory configured to store computer instructions and/or data associated with the display apparatus; at least one processor connected with the memory, configured to execute the computer instructions to enable the display apparatus to: monitor the camera status broadcast message sent from the camera service in the operating system, so as to determine whether the camera is activated by the application according to the camera status broadcast message; if the camera status broadcast message is a camera release message, indicating that the camera is not activated by the application, then the camera can be called by the global application of the display apparatus to capture the camera image, and then the human feature data is obtained from the camera image, so as to control the display apparatus to perform the corresponding function according to the control instruction corresponding to the human feature data. By monitoring the state of whether other applications enable the camera, when the camera is not activated by the application, that is, when the camera is idle, the global application can call the camera to capture the camera image, so as to identify the camera image to realize the control of the display apparatus, so that the management of the camera becomes orderly, and the global application can call the camera more conveniently, which is conducive to the human-computer interaction between the user and the display apparatus.

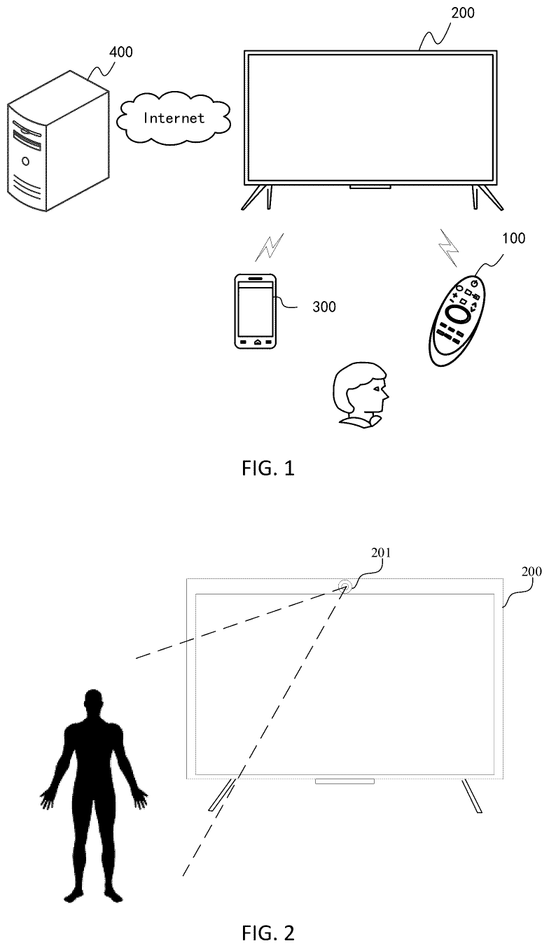

FIG. 1 is a schematic diagram of an operation scenario between a display apparatus and a control device according to some embodiments of the present application. As shown in FIG. 1, the figure includes a control device 100, a display apparatus 200, a smart device 300 and a server 400. A user can operate the display apparatus 200 through the smart device 300 or the control device 100 to turn on the display apparatus 200.

In some embodiments, the control device 100 can be a remote controller, and the communication between the remote controller and the display apparatus can include infrared protocol communication, Bluetooth protocol communication, wireless or other wired methods to control the display apparatus 200. The user can input user instructions through buttons on the remote controller, voice input, control panel input, etc. to control the display apparatus 200. In some embodiments, a mobile terminal, a tablet computer, a computer, a laptop computer, and other smart devices can also be used to control the display apparatus 200.

In some embodiments, the display apparatus 200 can also be controlled in ways other than the control device and the smart device. For example, the user's voice instruction control can be directly received through a module for obtaining voice instructions configured inside the display apparatus 200, or the user's voice instruction control can be received through a voice control device set outside the display apparatus 200, or the user's control can be received through touch or gestures.

In some embodiments, the smart device 300 can connect and communicate with software applications installed on display apparatus 200 through network communication protocols, achieving the purpose of one-to-one control operations and data communication. It is also possible to transfer the audio and video content displayed on smart device 300 to display apparatus 200, achieving synchronous display function.

In some embodiments, the display apparatus 200 can communicate data with the server 400 through various communication methods. The display apparatus 200 can be allowed to communicate and connect via a local area network (LAN), a wireless local area network (WLAN), and other networks. The server 400 can provide various contents and interactions to the display apparatus 200. The display apparatus 200 can be a liquid crystal display, an OLED display, or a projection display apparatus. In addition to providing a broadcast receiving television function, the display apparatus 200 can also provide an intelligent network television function that can provide a computer support function.

The display apparatus provided in the embodiments of the present application can have various implementation forms, for example, it can be a television, a smart television, a laser projection device, a monitor, an electronic bulletin board, an electronic table, etc. The embodiments of the present application do not limit the specific type of the display apparatus.

FIG. 2 is a schematic diagram of an application scenario of a display apparatus according to some embodiments of the present application, in which a user can control a display apparatus 200 through gestures. The display apparatus 200 can be provided with a camera 201, through which images can be taken, videos can be recorded, etc. The camera 201 can be a monocular camera, a binocular camera, or an infrared camera, which is only shown in the figure for example and is not specifically limited.

In the scenario shown in FIG. 2, the user can make a corresponding gesture, and at least one processor 250 of the display apparatus 200 can be configured to execute computer instructions stored in the memory of the display apparatus to enable the display apparatus 200 to: monitor the camera status broadcast message sent from the camera service in the operating system, and the camera status broadcast message is used to indicate whether the camera is activated by the application. In the case where the camera status broadcast message is a camera release message, indicating that the camera is not activated by the application, the camera can be called by the global application of the display apparatus 200 to capture the camera image, so that the camera captures the gesture made by the user, and then can obtain the human body feature data from the camera image, so as to control the display apparatus to perform the corresponding function according to the control instruction corresponding to the human body feature data.

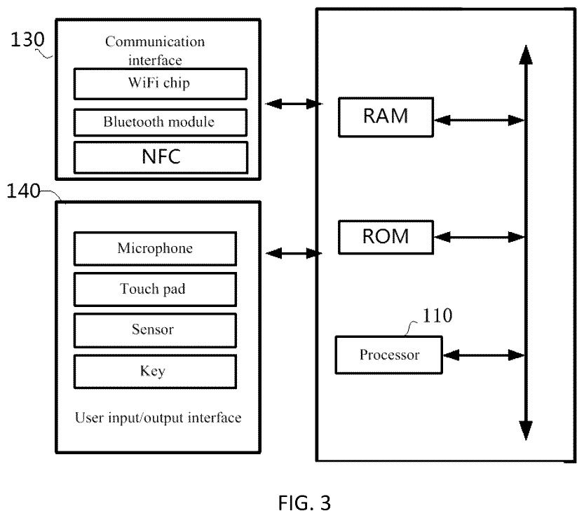

FIG. 3 is a configuration block diagram of a control device 100 provided in some embodiments of the present application. As shown in FIG. 3, the control device 100 can include a processor 110, a communication interface 130, a user input/output interface 140, a memory, and a power supply. The control device 100 can receive input operation instructions from a user, and convert the operation instructions into instructions that can be recognized and responded to by the display apparatus 200, thereby acting as an interactive intermediary between the user and the display apparatus 200. The communication interface 130 can be used to communicate with the outside, and can include at least one of a WIFI chip, a Bluetooth module, NFC or an alternative module. The user input/output interface 140 can include at least one of a microphone, a touchpad, a sensor, a button or an alternative module.

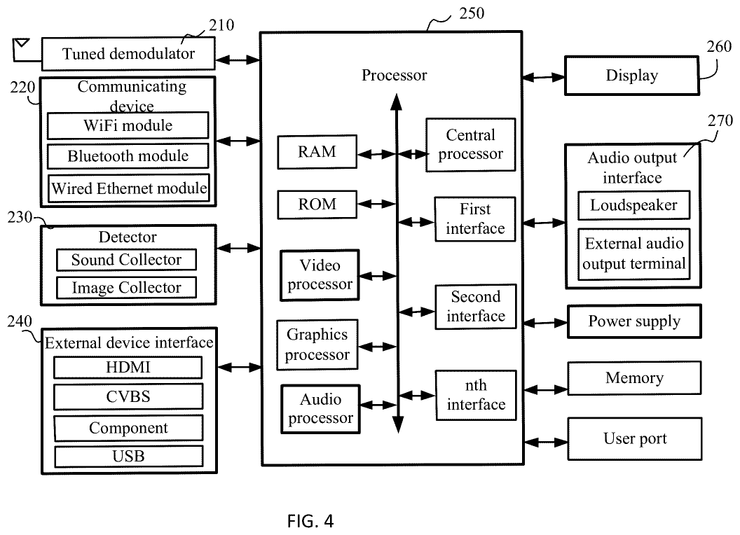

FIG. 4 is a hardware configuration block diagram of a display apparatus 200 provided in some embodiments of the present application. As shown in FIG. 4, the display apparatus 200 can include: a tuner-demodulator 210, a communicating device 220, a detector 230, an external device interface 240, at least one processor 250, a display 260, an audio output interface 270, a memory, a power supply, and at least one of a user interface (i.e., a user input interface). Among them, at least one processor 250 can include a central processing unit, a video processor, an audio processor, a graphics processor, a RAM, a ROM, and a first interface to an nth interface for input/output. The display 260 can be at least one of a liquid crystal display, an OLED display, a touch display, or a projection display, and can also be a projection device and a projection screen. The tuner-demodulator 210 can receive broadcast television signals by wired or wireless reception, and demodulate audio and video signals, such as and EPG data signals, from multiple wireless or wired broadcast television signals. The communicating device 220 can be a component for communicating with an external device or server according to various communication protocol types. For example: the communicating device can include at least one of: a Wifi module, a Bluetooth module, a wired Ethernet module, other network communication protocol chips, near field communication protocol chips, or an infrared receiver. The display apparatus 200 can establish the sending and receiving of control signals and data signals with the external control device 100 or the server 400 through the communicating device 220. The detector 230 can be used to capture signals from the external environment or interact with the outside. At least one processor 250 and the tuner-demodulator 210 can be located in different split devices, that is, the tuner-demodulator 210 can also be in an external device of the main device where at least one processor 250 is located, such as an external set-top box, etc. The user interface can be used to receive control signals from a control device (such as an infrared remote controller, etc.).

In some embodiments, the above-mentioned display apparatus can be a terminal device with a display function, such as a television, a mobile phone, a computer, a learning machine, etc.

In some embodiments, at least one processor 250 can control the operation of the display apparatus and respond to the user's operation through various software control programs stored in the memory. At least one processor 250 can control the overall operation of the display apparatus 200. The user can input a user instruction through a graphical user interface (GUI) displayed on the display 260, and the user input interface can receive the user input instruction through the graphical user interface (GUI). Alternatively, the user can input a user instruction by inputting a specific sound or gesture, and the user input interface can recognize the sound or gesture through a sensor to receive the user input instruction.

The output interface (display 260 and/or audio output interface 270) can be configured to output user interaction information; the communicating device 220 can be used to communicate with the server 400 or other devices.

According to some embodiments of the present application, a display apparatus 200 can include:
a memory, configured to store computer instructions and/or data associated with the display apparatus;
at least one processor 250, connected with the memory, where the at least one processor is configured to execute the computer instructions to enable the display apparatus to:
monitor a camera status broadcast message sent from a camera service in an operating system, where the camera status broadcast message is used to indicate whether a camera is activated by an application;
based on that the camera status broadcast message is a camera release message, call the camera to capture a camera image through a global application of the display apparatus, where the camera release message is used to indicate that the camera is not activated by the application;
obtain human feature data from the camera image, and control the display apparatus to execute a corresponding function according to a control instruction corresponding to the human feature data.

The display apparatus 200 can monitor the camera status broadcast message sent from the camera service in the operating system to determine whether the camera is activated by the application according to the camera status broadcast message; if the camera status broadcast message is a camera release message, indicating that the camera is not activated by the application, the global application of the display apparatus can call the camera to capture the camera image, and then obtain the human body feature data from the camera image, so as to control the display apparatus to perform the corresponding function according to the control instruction corresponding to the human body feature data. By monitoring the status of whether other applications enable the camera, when the camera is not activated by the application, that is, when the camera is idle, the global application can call the camera to capture the camera image, so as to identify the camera image to realize the control of the display apparatus, so that the management of the camera can become orderly, and the global application can call the camera more conveniently, which is conducive to the human-computer interaction between the user and the display apparatus.

In some embodiments, before calling the camera to capture the camera image through the global application of the display apparatus based on that the camera status broadcast message is the camera release message, the at least one processor 250 can be further configured to execute the computer instruction to enable the display apparatus to:
based on that the camera status broadcast message is a camera activation message, control a display to display a camera activation icon on a current user interface to prompt an user that the camera is being activated by the application;
for calling the camera to capture the camera image through the global application of the display apparatus based on that the camera status broadcast message is the camera release message, the at least one processor 250 can be further configured to execute the computer instruction to enable the display apparatus to:
based on that the camera status broadcast message is the camera release message, control the display to remove a display of the camera activation icon on the current user interface, and call the camera to capture the camera image through the global application of the display apparatus.

In some embodiments, at least one processor 250 can obtain human feature data from a camera image and can be specifically configured to execute the computer instructions to enable the display apparatus to:
detect whether the camera image includes valid human features, where the valid human features can include: gesture features and/or human posture features;
based on that the camera image includes the valid human features, obtain the human feature data from the camera image.

In some embodiments, after detecting whether the camera image includes the valid human features, the at least one processor 250 can be further configured to execute the computer instruction to enable the display apparatus to:
based on that the camera image does not include the valid human features, determine whether the camera is blocked;
based on that the camera is blocked, adjust a frequency at which the global application calls the camera from an initial frequency to a target frequency, and/or output a first prompt message;
where the target frequency is less than the initial frequency, and the first prompt message can be used to prompt the user that the camera of the display apparatus is blocked.

In some embodiments, for adjusting the frequency at which the global application calls the camera from the initial frequency to the target frequency, and/or outputting the first prompt message based on that the camera is blocked, the at least one processor 250 can be further configured to execute the computer instructions to enable the display apparatus to:
capture an image to be detected by the camera;
based on that a difference between a brightness value of the image to be detected and a minimum brightness value is less than or equal to a first preset value, adjust the frequency at which the global application calls the camera from the initial frequency to the target frequency, and/or output the first prompt message.

In some embodiments, the brightness value can be represented by an RGB value or a grayscale value; and/or,
the brightness value of the image to be detected can includes at least one of:
a brightness value of each pixel in the image to be detected;
a brightness value of each pixel in a partial area of the image to be detected;
an average brightness value of all pixels in the image to be detected; or
an average brightness value of pixels in a partial area of the image to be detected.

In some embodiments, for adjusting the frequency at which the global application calls the camera from the initial frequency to the target frequency, and/or outputting the first prompt message based on that the camera is blocked, the at least one processor 250 can be further configured to execute the computer instructions to enable the display apparatus to:
capture an image to be detected by the camera;
determine at least one horizontal detection area and at least one vertical detection area from the image to be detected;
based on that differences between brightness values of any pixels in a target direction in a target detection area are less than or equal to a second preset value, adjust the frequency at which the global application calls the camera from the initial frequency to the target frequency, and/or output the first prompt message;
where the target detection area is a horizontal detection area, and the target direction is a vertical direction; or the target detection area is a vertical detection area, and the target direction is a horizontal direction.

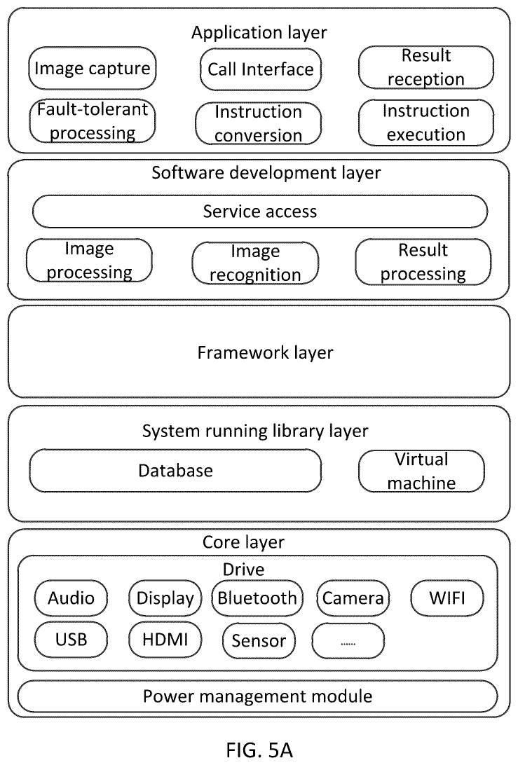

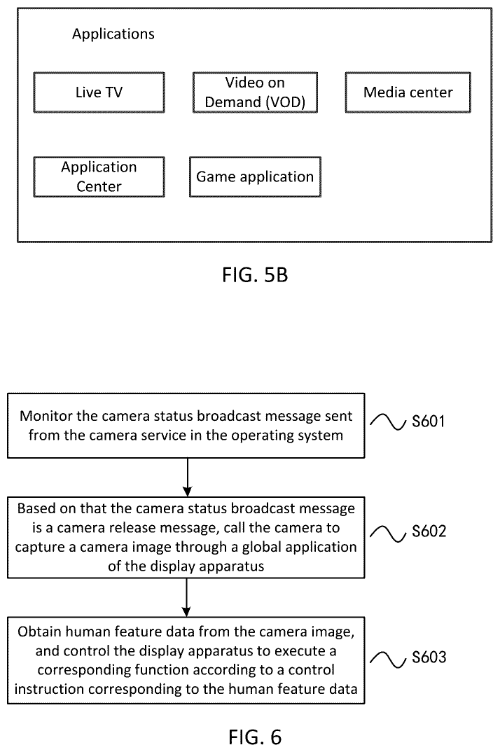

As shown in FIG. 5A, FIG. 5A is a schematic diagram of the software configuration in the display apparatus 200 provided in some embodiments of the present application. As shown in FIG. 5A, the system is divided into four layers, from top to bottom, namely, the application (Applications) layer (referred to as “application layer”), the software development layer (Software Development Kit, SDK), the application framework (Application Framework) layer (referred to as “framework layer”), the Android runtime (Android runtime) and the system runtime library layer (referred to as “system library layer”), and the kernel layer.

In some embodiments, at least one application can be running in the application layer, and these applications can be window programs, system settings programs, clock programs, etc. provided by the operating system, or applications developed by third-party developers. In specific implementations, the applications in the application layer can include but not be limited to the above examples.

In some embodiments, the system runtime layer can provide support for the upper layer, namely the framework layer. When the framework layer is used, the Android operating system can run the C/C++ library contained in the system runtime layer to implement the functions to be implemented by the framework layer.

In some embodiments, the kernel layer can be a layer between hardware and software, and can include at least one of the following drivers: audio driver, display driver, Bluetooth driver, camera driver, WIFI driver, USB driver, HDMI driver, sensor driver (such as fingerprint sensor, temperature sensor, pressure sensor, etc.), and power driver, etc.

Among them, the application layer can be responsible for calling the camera driver and calling the SDK layer interface to pass the captured images to the SDK layer for AI calculation, so as to receive the AI algorithm results such as gestures and human key point data recognized by the SDK layer. The global application (such as AI Sense) in the application layer can be used to manage the status of the camera, including but not limited to: whether the camera is idle, whether the camera is blocked, the usage status of the camera, etc. Hishow can represent the application that needs to occupy the camera for shooting, and Hishow and AI applications preempt the camera. The global application can register the power-on broadcast when the display apparatus is turned on. After receiving the power-on broadcast, the service can be started to register the camera broadcast and monitor the camera status. Then, according to the monitored camera status, operations such as calling the AI interface and adjusting the frequency of the AI interface can be executed, and the returned AI results can be processed to convert the AI results into control instructions to control the display apparatus to perform corresponding operations to achieve corresponding functions.

The SDK layer can encapsulate image processing and image recognition models, and expand the service access interface. The kernel layer can contain at least one of the following drivers: audio driver, display driver, Bluetooth driver, camera driver, WIFI driver, USB driver, HDMI driver, sensor driver (such as fingerprint sensor, temperature sensor, pressure sensor, etc.), and power driver, etc.

The framework layer can be used to modify the logic of the system library layer. When the system library layer obtains the status message of the camera being used, it can record the package name and usage status of the application using the camera, and send a broadcast indicating that the camera is occupied; when the camera is released, the usage mark can be cleared and a broadcast message indicating that the camera is idle can be sent.

FIG. 5B is a schematic diagram of the icon control interface display of an application in the display apparatus 200 according to one or more embodiments of the present application. As shown in FIG. 5B, the application layer can include at least one application that can display a corresponding icon control in the display, such as: a live TV application icon control, a video on demand application icon control, a media center application icon control, an application center icon control, a game application icon control, etc.

A processing method for a display apparatus according to some embodiments of the present application can be implemented based on the above-mentioned display apparatus 200.

In order to explain the present solution in more detail, the following can be explained in an exemplary manner in conjunction with FIG. 6. It can be understood that the steps involved in FIG. 6 can include more steps or fewer steps in actual implementation, and the order of these steps may also be different, so as to implement a processing method for a display apparatus in some embodiments of the present application.

As shown in FIG. 6, FIG. 6 is a flowchart of a processing method for a display apparatus according to some embodiments of the present application. The method can include the following steps S601 to S603.

S601: monitor the camera status broadcast message sent from the camera service in the operating system.

The camera status broadcast message can be used to indicate whether the camera is activated by the application. The camera status broadcast message can be divided into a camera activation message and a camera release message. The camera activation message can indicate that the camera is activated by the application, and the camera release message can indicate that the camera is not activated by the application.

In some embodiments, when the camera status broadcast message sent from the camera service in the operating system is monitored as a camera activation message, it can indicate that the camera is being activated by the application. The embodiments of the present application provide an implementation method: if the camera status broadcast message is a camera activation message, the display can be controlled to display a camera activation icon on the current user interface to prompt the user that the camera is being activated by the application. This can allow the user to perceive the camera being activated, which can help protect the user's privacy.

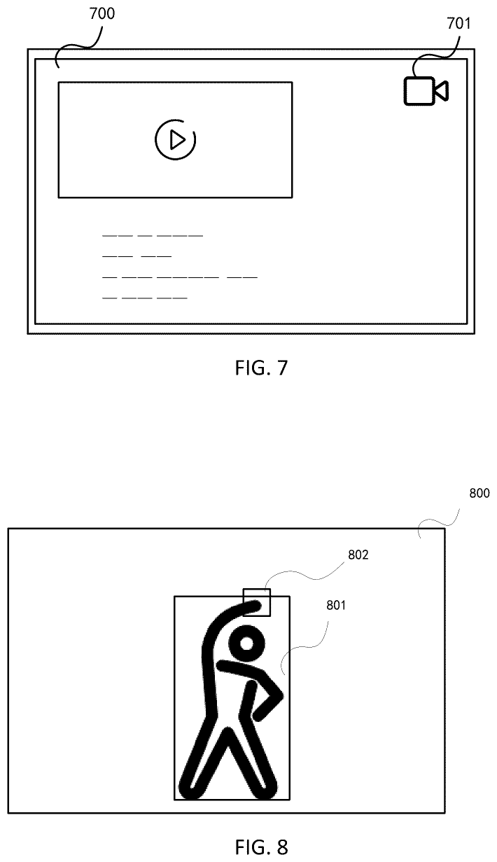

As shown in FIG. 7, FIG. 7 is a schematic diagram of a user interface in some embodiments of the present application, showing a user interface 700 and a camera activation icon 701. When the camera status broadcast message sent from the camera service in the operating system is monitored as a camera activation message, the user interface 700 can display the camera activation icon 701.

S602: based on that the camera status broadcast message is a camera release message, call the camera to capture a camera image through a global application of the display apparatus.

The camera release message can be used to indicate that the camera is not activated by the application.

Global applications can refer to AI applications that can use cameras in all scenarios, such as general video applications that can obtain user images while playing movies to recognize user gestures to control volume, etc. Global applications can be background applications that are invisible to users. When global applications call the camera, users cannot sense whether the camera is turned on.

In some embodiments, when the camera status broadcast message sent from the camera service in the operating system can be monitored to be a camera release message, it can indicate that the camera has not been activated by the application and is in an idle state. The embodiments of the present application provide an implementation method: if the camera status broadcast message is a camera release message, the display can be controlled to remove the display of the camera activation icon on the current user interface, and the camera can be called through the global application of the display apparatus to capture the camera image.

S603: obtain human feature data from the camera image, and control the display apparatus to execute a corresponding function according to a control instruction corresponding to the human feature data.

Among them, human body feature data can include but is not limited to: human body contour feature data, hand gesture feature data, human body posture feature data, human body key point feature data, and facial feature data.

In some embodiments, in the process of obtaining human body feature data from the camera image, it can be first detected whether there are valid human body features in the camera image, and the valid human body features can include: gesture features, and/or, human body posture features. In the case where the valid human body features are detected in the camera image, the human body feature data can be obtained from the camera image. It can be understood that the valid human body features are preset partial human body feature data corresponding to the existence of control instructions. For example, the camera image can contain a complete user body image. When the valid human body feature is a gesture feature, it can be detected that the camera image includes the gesture feature. Therefore, the camera image can determine the corresponding control instruction after AI calculation to meet the user's gesture control display apparatus needs.

As shown in FIG. 8, FIG. 8 is a schematic diagram of a camera image according to some embodiments of the present application, and the figure shows the human body feature data 801 and the effective human body feature 802 in the camera image 800. After detecting the camera image 800, it can be determined that there are effective human body features 802 in the camera image 800, and then the human body feature data 801 included in the camera image 800 can be obtained, so as to perform AI calculation on the human body feature data 801, and realize controlling the display apparatus to perform corresponding functions according to the control instructions corresponding to the human body feature data 801.

When it is detected that there are no valid human features in the camera image, it can be determined whether the camera is blocked. It is understandable that, in order to protect user privacy, the camera of the display apparatus can be equipped with a mechanical switch. When the camera is not in use, turning off the mechanical switch can fundamentally prevent the camera from shooting without the user's perception, which can effectively protect privacy. Therefore, if the global application of the display apparatus calls the camera to capture the camera application and there are no human features, it can be further determined whether the camera is blocked.

If the camera is blocked, the frequency of the global application calling the camera can be adjusted from the initial frequency to the target frequency, where the target frequency can be lower than the initial frequency. In this way, when the camera is blocked, the frequency of the camera shooting is reduced, which can be beneficial to saving power consumption of the display apparatus.

In some embodiments, when the camera is blocked, a first prompt message can be output, and the first prompt message can be used to prompt the user that the camera of the display apparatus is blocked, so that the user can remove the camera blockage in time when the global application needs to control the display apparatus. Alternatively, when the camera is blocked, the frequency of the global application calling the camera can be adjusted from the initial frequency to the target frequency, and the first prompt message can be output.

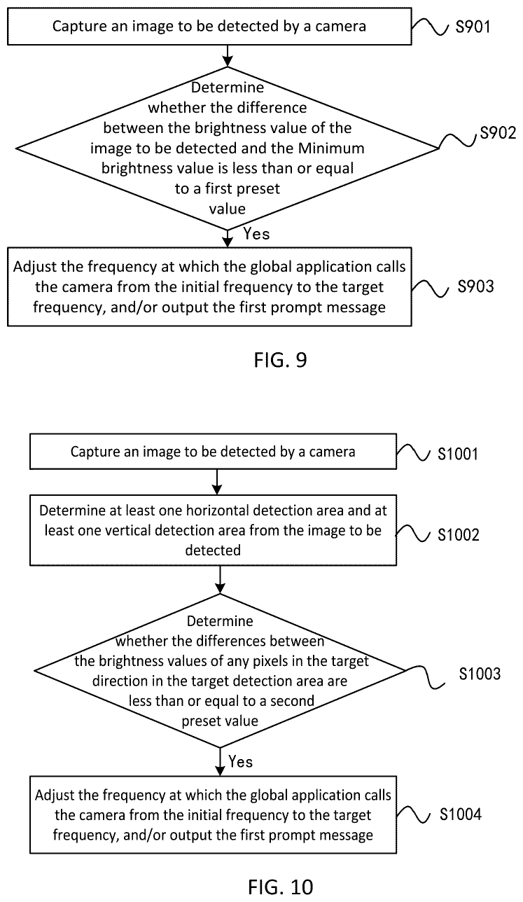

In some embodiments, as shown in FIG. 9, FIG. 9 is a second flow chart of a processing method for a display apparatus according to some embodiments of the present application, including the following steps S901 to S903.

S901: capture an image to be detected by a camera.

In some embodiments, after determining that the camera is blocked, the camera can be used to capture an image to be detected, so as to determine whether the camera is actually blocked by re-calling the camera for shooting, thereby reducing misjudgment and lowering the error rate.

S902: determine whether the difference between the brightness value of the image to be detected and the minimum brightness value is less than or equal to a first preset value.

Among them, the first preset value is a preset brightness threshold corresponding to the image captured when the camera is blocked. It is understandable that after the camera is blocked, the image captured by calling the camera can be a pure black image. There is also light leakage caused by human or error when the mechanical switch blocks the camera. The specific value of the first preset value can be set according to the actual situation, and this application does not limit it.

In some embodiments, the brightness value can be represented by an RGB value or a grayscale value, and/or the brightness value of the image to be detected can include at least one of the following situations: a brightness value of each pixel in the image to be detected; a brightness value of each pixel in a partial area of the image to be detected; an average brightness value of all pixels in the image to be detected; or an average brightness value of pixels in a partial area of the image to be detected.

In some embodiments, the first preset value can be 30, the difference between the R value of each pixel in the image to be detected and the minimum B value is calculated, and then it can be determined whether the difference is less than or equal to the first preset value 30.

When the difference between the brightness value of the image to be detected and the minimum brightness value is less than or equal to the first preset value, step S903 can be executed.

When the difference between the brightness value of the image to be detected and the minimum brightness value is greater than the first preset value, it can indicate that the camera is not blocked. In some embodiments, the frequency of calling the camera by the global application can be increased.

S903: adjust the frequency at which the global application calls the camera from the initial frequency to the target frequency, and/or output the first prompt message.

The above steps capture the image to be detected by re-calling the camera, so as to accurately determine whether the camera is blocked according to the image to be detected.

In some embodiments, as shown in FIG. 10, FIG. 10 is a flowchart diagram of a processing method for a display apparatus according to some embodiments of the present application, including the following steps S1001 to S1003.

S1001: capture an image to be detected by a camera.

S1002: determine at least one horizontal detection area and at least one vertical detection area from the image to be detected.

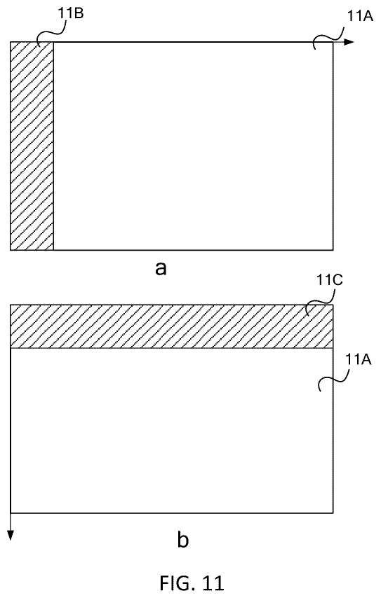

As shown in FIG. 11, FIG. 11 is a schematic diagram of the horizontal detection area and the vertical detection area provided in some embodiments of the present application. FIG. 11 can show the image to be detected 11A. In the coordinate system where the image to be detected 11A is located, at least one horizontal detection area 11B can be determined from the coordinate origin along the positive direction of the horizontal axis, as shown in a in FIG. 11; and at least one vertical detection area 11C can be determined from the coordinate origin along the vertical axis, as shown in b in FIG. 11.

S1003: determine whether the differences between the brightness values of any pixels in the target direction in the target detection area are less than or equal to a second preset value.

The brightness value can be represented by RGB or grayscale value.

The second preset value can be a preset brightness threshold. The specific value can be set according to actual conditions and is not limited in the present application.

The target detection area can be a horizontal detection area, and the target direction can be a vertical direction; or, the target detection area can be a vertical detection area, and the target direction can be a horizontal direction.

In some embodiments, the difference between the brightness values of any pixels in the target direction in the target area can be calculated, and then it can be determined whether the difference is less than or equal to the second preset value. For example, the difference between the brightness values of any pixels in the vertical direction of the horizontal detection area can be calculated, and then it can be determined whether the difference is less than or equal to the second preset value.

When the differences between the brightness values of any pixels in the target direction in the target detection area are less than or equal to the second preset value, step S1004 can be executed.

When the difference between the brightness values of any pixels in the target direction in the target detection area is greater than the second preset value, it means that the camera is not actually blocked. In some embodiments, the frequency of calling the camera by the global application can be increased.

S1004: adjust the frequency at which the global application calls the camera from the initial frequency to the target frequency, and/or output the first prompt message.

If the differences between the brightness values of any pixels in the target direction in the target detection area are less than or equal to the second preset value, the frequency of the global application calling the camera can be adjusted from the initial frequency to the target frequency, and/or the first prompt message can be output.

The above steps can divide the re-capture image to be detected into at least one horizontal detection area and at least one vertical detection area, and accurately and quickly determine whether the camera is blocked by comparing the difference between any pixels in the horizontal direction, or comparing the difference between any pixels in the vertical direction. Therefore, based on that the camera is blocked, the frequency of the camera can be reduced to reduce the energy consumption of the display apparatus; and/or, output a first prompt message to prompt the user that the camera is blocked.

In summary, the embodiments of the present application provide a first processing method for a display apparatus, which first can monitor the camera status broadcast message sent from the camera service in the operating system to determine whether the camera is activated by the application according to the camera status broadcast message; if the camera status broadcast message is a camera release message, indicating that the camera is not activated by the application, the camera is called by the global application of the display apparatus to capture the camera image, and then the human body feature data is obtained from the camera image, so as to control the display apparatus to perform the corresponding function according to the control instruction corresponding to the human body feature data. By monitoring the status of whether other applications enable the camera, when the camera is not activated by the application, that is, when the camera is idle, the global application can calls the camera to capture the camera image to identify the camera image to realize the control of the display apparatus, so that the management of the camera can become orderly, and the global application can call the camera more conveniently, which can be conducive to the human-computer interaction between the user and the display apparatus.

In the related art, the display apparatus can use a built-in or external camera to capture user images for image recognition, thereby realizing functions such as gesture control, AI fitness, and somatosensory games. Due to the limited camera angle, fixed position, or the limited movable distance between the user being captured and the camera, it is difficult to capture images including complete gestures or the user's full body. The data information contained in the captured image that needs to be processed by the image recognition algorithm is incomplete, which can further lead to inaccurate results of the image recognition algorithm and affect the human-computer interaction performance.

In order to solve some or all of the above-mentioned technical problems, some embodiments of the present application provide another processing method for a display apparatus, the method including: controlling the camera to capture a target image, and display a video page on a display, where the target image is displayed on the video page; performing human body image segmentation on the target image to determine a rectangular area of a human body contour, and obtaining vertex coordinates of the rectangular area of the human body contour in the video page; determining an adjustment parameter according to the vertex coordinates of the rectangular area of the human body contour; and adjusting a position of the camera according to the adjustment parameter. Thus, the display apparatus can control the camera to capture a target image including a complete rectangular area of the human body contour, thereby achieving fast and accurate adjustment of a position of the camera and improving human-computer interaction performance.

Still in the scene shown in FIG. 2, the user can make a corresponding gesture, and the display apparatus 200 can control the camera to capture the target image, and display the video page in the display, so as to display the target image in real time in the video page, and then perform human image segmentation on the target image, determine the rectangular area of the human body contour in the target image, and obtain the vertex coordinates of the rectangular area of the human body contour in the video page, and then determine the adjustment parameters according to the vertex coordinates of the rectangular area of the human body contour, and adjust a position of the camera according to the adjustment parameters, so that the camera can capture the complete gesture image made by the user. By obtaining the vertex coordinates of the rectangular area of the human body contour in the video page in real time, it is possible to quickly and accurately analyze whether the rectangular area of the human body contour is completely in the video page, so as to determine whether the complete user gesture is captured, which is conducive to the user controlling the display apparatus through gestures.

According to the above another processing method for a display apparatus, the at least one processor 250 included in the display apparatus 200 according to some embodiments of the present application can be further configured to execute computer instructions stored in the memory of the display apparatus 200 to enable the display apparatus 200 to:
control the camera to capture a target image, and display a video page on a display, where the target image is displayed on the video page;
perform human body image segmentation on the target image to determine a rectangular area of a human body contour, and obtain vertex coordinates of the rectangular area of the human body contour in the video page;
determine an adjustment parameter according to the vertex coordinates of the rectangular area of the human body contour; and
adjust a position of the camera according to the adjustment parameter.

The above-mentioned display apparatus 200 can control the camera to capture the target image and display the video page on the display. The target image can be displayed in the video interface, and then the human body image segmentation can be performed on the target image to determine the rectangular area of the human body contour, and the vertex coordinates of the rectangular area of the human body contour in the video page can be obtained; then the adjustment parameters can be determined according to the vertex coordinates of the rectangular area of the human body contour, and a position of the camera can be adjusted according to the adjustment parameters, so that the rectangular area of the human body contour can be completely in the video interface, and the display apparatus can capture the target image including the complete human body, and then recognize such a target image, determine the corresponding control instructions to perform corresponding operations, which can meet the user's diverse needs such as gesture control, somatosensory games, AI fitness, etc., and improve the human-computer interaction performance.

In some embodiments, before determining the adjustment parameters according to the vertex coordinates of the rectangular area of the human body contour, at least one processor 250 can be further configured to execute computer instructions to enable the display apparatus to:
obtain vertex coordinates of a preset effective control area in the video page;
for determining the adjustment parameter according to the vertex coordinates of the rectangular area of the human body contour, the at least one processor 250 can be further configured to execute the computer instructions to enable the display apparatus to:
determine the adjustment parameter according to the vertex coordinates of the rectangular area of the human body contour and the vertex coordinates of the preset effective control area in the video page.

In some embodiments, for determining the adjustment parameter according to the vertex coordinates of the rectangular area of the human body contour and the vertex coordinates of the preset effective control area in the video page, the at least one processor 250 is further configured to execute the computer instructions to enable the display apparatus to:
determine whether the rectangular area of the human body contour overlaps with a margin area in the video page according to the vertex coordinates of the rectangular area of the human body contour and the vertex coordinates of the preset effective control area in the video page; where the margin area is an area in the video page excluding the preset effective control area;
based on that the rectangular area of the human body contour overlaps with the margin area in the video page, determine positional information of an overlapping area in the video page;
determine the adjustment parameter according to the positional information of the overlapping area in the video page.

In some embodiments, the adjustment parameter is an adjustment direction, for determining the adjustment parameter according to the positional information of the overlapping area in the video page, the at least one processor 250 can be further configured to execute the computer instructions to enable the display apparatus to:
based on that the overlapping area is in a first direction in the video page, the adjustment direction of the camera is determined to be the first direction.

In some embodiments, the adjustment parameter is an adjustment direction, for determining the adjustment parameter according to the vertex coordinates of the rectangular area of the human body contour, the at least one processor 250 can be further configured to execute the computer instructions to enable the display apparatus to:
based on that the rectangular area of the human body contour does not comprise a complete human body, determine a second direction of a position where a human body portion is not captured relative to the video page;
determine that the adjustment direction of the camera is the second direction.

In some embodiments, at least one processor 250 can be further configured to execute computer instructions to enable the display apparatus to:
based on that the rectangular area of the human body contour does not comprise a complete human body, calculate a first size of a human body portion that is not captured according to the vertex coordinates of the rectangular area of the human body contour;
obtain a second size of a target background area, where the target background area is a background area in the video page in a direction opposite to a direction where the human body portion not captured is located;
based on that the first size is less than or equal to the second size, determine a second direction of a position where the human body portion is not captured relative to the video page; and determine that the adjustment direction of the camera is the second direction;
based on that the first size is larger than the second size, output a first prompt message, where the first prompt message can be used to prompt the user to stay away from the camera;
where the first size is a first width, and the second size is a second width; or the first size is a first length, and the second size is a second length.

In some embodiments, for calculating a first size of a human body portion that is not captured according to the vertex coordinates of the rectangular area of the human body contour, the at least one processor 250 can be further configured to execute the computer instructions to enable the display apparatus to:
determine a third size of a human body portion captured in the video page;
calculate the first size of the human body portion that is not captured in the video page according to the third size to a target size ratio;
where the target size ratio is a size ratio of the human body portion that is not captured in the complete human body.

In some embodiments, the at least one processor 250 can be further configured to execute the computer instructions to enable the display apparatus to:
based on that the rectangular area of the human body contour comprises the complete human body, determine a size of the complete human body in the video page;
based on that the size of the complete human body in the video page is smaller than half of a size of the video page, output a second prompt message; where the second prompt message is used to prompt the user to get closer to the camera.

Another processing method for a display apparatus provided in some embodiments of the present application can be implemented according to the above-mentioned display apparatus.

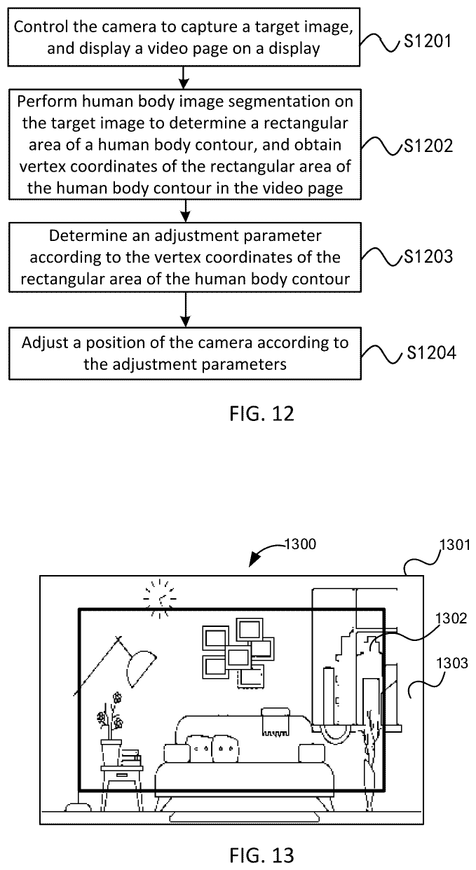

As shown in FIG. 12, FIG. 12 is a flowchart of another processing method for a display apparatus according to some embodiments of the present application. The method can include the following steps S1201 to S1204.

S1201, control the camera to capture a target image, and display a video page on a display.

Among them, the target image can be displayed in the video page.

As shown in FIG. 13, FIG. 13 is a schematic diagram of a video page according to some embodiments of the present application. The figure shows a video page 1300, in which a target image 1301 can be displayed. The target image 1301 can be displayed in the video page 1300 in a full-screen manner.

It should be noted that when the user uses the display apparatus to capture and identify full-body limb images, a certain amount of margin space can be reserved for the camera to capture the target image. A part of the area in the video page can be pre-set as the effective control area, and the remaining area can be set as the margin area in the form of a gray mask. Referring to the preset effective control area 1302 and margin area 1303 in FIG. 13, the display apparatus can analyze and process the image information included in the preset effective control area.

S1202: perform human body image segmentation on the target image to determine a rectangular area of a human body contour, and obtain vertex coordinates of the rectangular area of the human body contour in the video page.

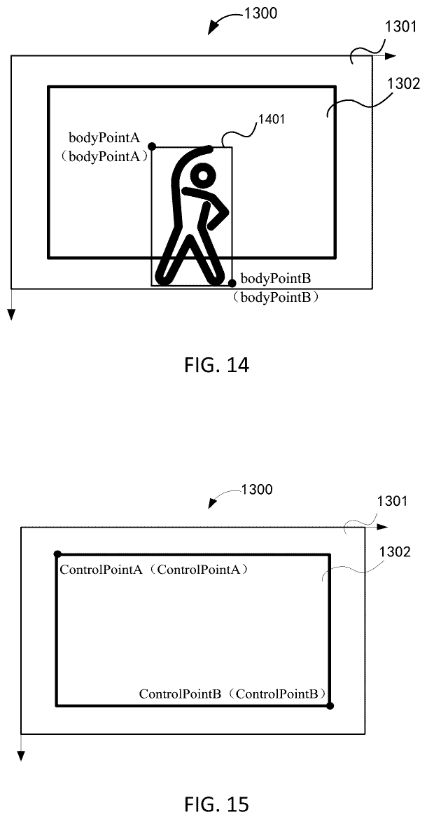

In some embodiments, AI algorithms such as image processing models and image recognition models encapsulated by the SDK layer can perform human image segmentation on the target image to segment the human image from the target image, and then mark the rectangular area of the human body contour in the target image, as shown in FIG. 14, which is a schematic diagram of the rectangular area of the human body contour according to some embodiments of the present application. The figure can show a video page 1300, in which a target image 1301 can be displayed. After human body image segmentation is performed on the target image 1301, a rectangular area of the human body contour 1401 can be obtained.

In some embodiments, the coordinates of the rectangular area of the human body contour in the video page are calculated by the AI algorithm. It can be understood that the AI algorithm can output the coordinate values of the four sides of the rectangular area of the human body contour: top, bottom, left, and right, where top can be the upper ordinate of the rectangular area of the human body contour, bottom can be the lower ordinate of the rectangular area of the human body contour, left can be the left horizontal coordinate of the rectangular area of the human body contour, and right can be the right horizontal coordinate of the rectangular area of the human body contour. Then, according to the four boundary values of top, bottom, left, and right, the vertex coordinates of the human body contour boundary area can be obtained, which can be the upper left vertex coordinates and the lower right vertex coordinates, or the upper right vertex coordinates and the lower left vertex coordinates. Referring to FIG. 14, the upper left vertex bodyPointA (left, top) and the lower right vertex bodyPointB (right, bottom) can be obtained.

S1203: determine an adjustment parameter according to the vertex coordinates of the rectangular area of the human body contour.

The adjustment parameter can be a parameter for adjusting the direction of the camera or a parameter for adjusting the angle of the camera.

In some embodiments, before determining the adjustment parameters according to the vertex coordinates of the rectangular area of the human body contour, the vertex coordinates of the preset effective control area in the video page can be obtained, where the size of the preset effective control area can be fixed, thereby obtaining the vertex coordinates of the preset effective control area in the video coordinate system corresponding to the video page, as shown in FIG. 9, and FIG. 15 is a schematic diagram of the vertex coordinates of the effective control area according to some embodiments of the present application, the upper left corner vertex coordinates controlPointA (X1, Y1) and the lower right corner vertex coordinates controlPointB (X2, Y2) of the preset effective control area 1302. Then, the adjustment parameters can be determined according to the vertex coordinates of the rectangular area of the human body contour and the vertex coordinates of the preset effective control area in the video page.

In some embodiments, compare the horizontal coordinate left of the upper left corner vertex bodyPointA of the rectangular area of the human body contour to determine whether it is less than the horizontal coordinate X1 of the preset upper left corner vertex coordinate controlPointA of the effective control area; or, compare the horizontal coordinate right of the lower right corner vertex bodyPointB of the rectangular area of the human body contour to determine whether it is greater than the horizontal coordinate X2 of the preset lower right corner vertex coordinate controlPointB of the effective control area; or, compare the vertical coordinate top of the upper left corner vertex bodyPointA of the rectangular area of the human body contour to determine whether it is greater than the vertical coordinate Y1 of the preset upper left corner vertex coordinate controlPointA of the effective control area; or, compare the vertical coordinate bottom of the lower right corner vertex bodyPointB of the rectangular area of the human body contour to determine whether it is less than the vertical coordinate Y2 of the preset lower right corner vertex coordinate controlPointB of the effective control area.

When left is less than X1, it means that the rectangular area of the human body contour can exceed the left boundary of the preset effective control area, and the camera can be determined to be adjusted to the left. The camera can be adjusted to the left with the camera itself as the reference system. The adjustment angle can be calculated according to the difference between left and X1. For details, please refer to the relevant technology, and the present application will not go into details. In some embodiments, when left is less than X1, a prompt message can be generated, and the prompt message can be used to prompt the user to adjust the camera to the right, or prompt the user to move to the left. This is to adjust the position of the camera or move the user by himself with the user himself as the reference system, so that the rectangular area of the human body contour can be in the preset effective control area, which is beneficial for the display apparatus to identify the image information in the effective control area, so as to determine the user's interaction intention and improve the interaction performance.

When right is greater than X2, it means that the rectangular area of the human body contour can exceed the right boundary of the preset effective control area, and the camera can be determined to be adjusted to the right. The adjustment angle can be calculated according to the difference between right and X2. For details, please refer to the relevant technology, and the present application will not go into details. In some embodiments, when right is greater than X2, a prompt message can be generated, which can be used to prompt the user to adjust the camera to the right, or to prompt the user to move to the left, so that the rectangular area of the human body contour can be in the preset effective control area, which is beneficial for the display apparatus to identify the image information in the effective control area, so as to determine the user's interaction intention and improve the interaction performance.

When top is less than Y1, it means that the rectangular area of the human body contour can exceed the upper boundary of the preset effective control area, and the camera can be adjusted upward. The adjustment angle can be calculated according to the difference between top and Y1. For details, please refer to the relevant technology, and the present application will not elaborate on this. In some embodiments, when top is greater than Y1, a prompt message can be generated, which can be used to prompt the user to adjust the camera upward, or prompt the user to move away from the camera, so that the rectangular area of the human body contour can be in the preset effective control area.

When bottom is greater than Y2, it means that the human body contour area can exceed the lower boundary of the preset effective control area, and the camera can be adjusted downward. The adjustment angle can be calculated according to the difference between bottom and Y2. For details, please refer to the relevant technology, and the present application will not go into details. In some embodiments, when bottom is greater than Y2, a prompt message can be generated, which can be used to prompt the user to adjust the camera downward, or to prompt the user to move away from the camera, so that the rectangular area of the human body contour can be in the preset effective control area.

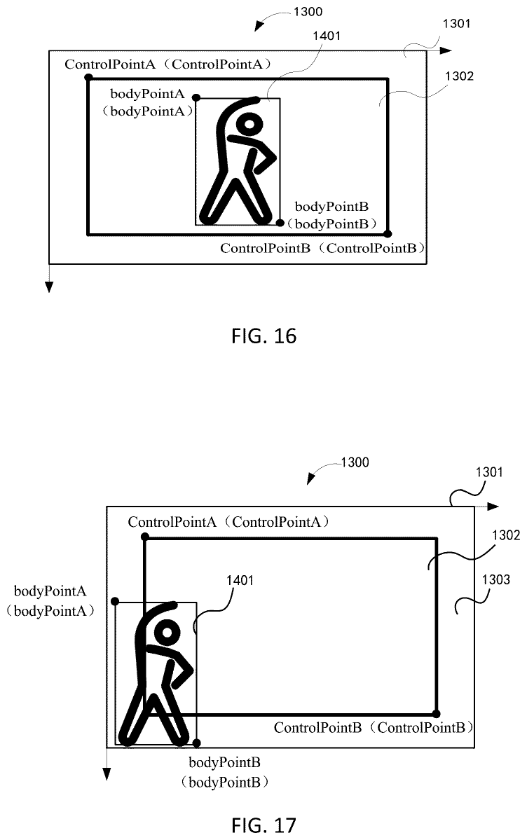

As shown in FIG. 16, FIG. 16 is a schematic diagram of a video page according to some embodiments of the present application, showing a video page 1300, a target image 1301, a preset effective control area 1302, and a rectangular area of the human body contour 1401. When left is greater than X1, right is less than X2, top is greater than Y1, and bottom is less than Y2, it means that the rectangular area of the human body contour 1401 can be completely in the preset effective control area 1302, and the display apparatus can perform image recognition on the effective control area 1302 of the video screen 1301, which can contain complete user limb information, and can accurately identify the user's interaction intention and improve the interaction performance. In some embodiments, in the process of determining the adjustment parameters according to the vertex coordinates of the rectangular area of the human body contour and the vertex coordinates of the effective control area preset in the video page, firstly, according to the vertex coordinates of the rectangular area of the human body contour and the vertex coordinates of the effective control area preset in the video page, it is determined whether the rectangular area of the human body contour overlaps with the margin area in the video page, and the margin area is the area in the video page other than the effective control area. In some embodiments, it can be determined whether the rectangular area of the human body contour overlaps with the margin area in the video page according to the vertex coordinates of the rectangular area of the human body contour: bodyPointA (left, top) and bodyPointB (right, bottom), and the vertex coordinates of the preset effective control area controlPointA (X1, Y1) and controlPointB (X2, Y2).

In some embodiments, it can be determined whether the horizontal coordinate left of the upper left corner vertex bodyPointA of the rectangular area of the human body contour is less than the horizontal coordinate X1 of the preset upper left corner vertex coordinate controlPointA of the effective control area; or, it can be determined whether the horizontal coordinate right of the lower right corner vertex bodyPointB of the rectangular area of the human body contour is greater than the horizontal coordinate X2 of the preset lower right corner vertex coordinate controlPointB of the effective control area; or, it can be determined whether the vertical coordinate top of the upper left corner vertex bodyPointA of the rectangular area of the human body contour is greater than the vertical coordinate Y1 of the preset upper left corner vertex coordinate controlPointA of the effective control area; or, it can be determined whether the vertical coordinate bottom of the lower right corner vertex bodyPointB of the rectangular area of the human body contour is less than the vertical coordinate Y2 of the preset lower right corner vertex coordinate controlPointB of the effective control area.

When the horizontal coordinate left of the upper left corner vertex bodyPointA of the rectangular area of the human body contour is smaller than the horizontal coordinate X1 of the upper left corner vertex coordinate controlPointA of the preset effective control area, it means that the rectangular area of the human body contour can overlap with the margin area in the video page, and then the orientation information of the overlapping area in the video page can be determined, and the first direction of the overlapping area in the video interface can be obtained as left, so it is determined to adjust the camera to the left, and the adjustment angle can be calculated according to the difference between left and X1.

As shown in FIG. 17, FIG. 17 is a second schematic diagram of a video page according to some embodiments of the present application, showing a video page 1300, a target image 1301, a preset effective control area 1302, a margin area 1303, and a rectangular area of the human body contour 1401. The horizontal coordinate left of the upper left corner vertex bodyPointA of the rectangular area of the human body contour 1401 can be smaller than the horizontal coordinate X1 of the upper left corner vertex coordinate controlPointA of the preset effective control area 1302, and can overlap with the margin area 1303. The overlapping area is the left side of the video page 1300. Then, it is determined to adjust the camera to the left, and the rectangular area of the human body contour 1401 can move to the right relative to the video page 1300 until it is completely in the preset effective control area 1302, so as to facilitate subsequent AI calculations to identify the image information contained in the preset effective control area 1302.

When the horizontal coordinate right of the vertex bodyPointB in the lower right corner of the rectangular area of the human body contour is greater than the horizontal coordinate X2 of the vertex coordinate controlPointB in the lower right corner of the preset effective control area, it means that the rectangular area of the human body contour can overlap with the margin area in the video page, and then the orientation information of the overlapping area in the video page can be determined, and the first direction of the overlapping area in the video interface is right, so it is determined to adjust the camera to the right, and the adjustment angle can be calculated according to the difference between right and X2.

When the vertical coordinate top of the upper left corner vertex bodyPointA of the rectangular area of the human body contour is greater than the vertical coordinate Y1 of the upper left corner vertex coordinate controlPointA of the preset effective control area, it means that the rectangular area of the human body contour can overlap with the margin area in the video page, and then the orientation information of the overlapping area in the video page can be determined, and the first direction of the overlapping area in the video interface can be obtained as upward, so it is determined to adjust the camera upward, and the adjustment angle can be calculated according to the difference between top and Y1.

When the vertical coordinate bottom of the vertex bodyPointB in the lower right corner of the rectangular area of the human body contour is less than the vertical coordinate Y2 of the vertex coordinate controlPointB in the lower right corner of the preset effective control area, it means that the rectangular area of the human body contour can overlap with the margin area in the video page, and then the orientation information of the overlapping area in the video page can be determined, and the first direction of the overlapping area in the video interface can be obtained as downward, so it is determined to adjust the camera downward, and the adjustment angle can be calculated according to the difference between bottom and Y2.

In some embodiments, the adjustment parameter can be an adjustment direction, and the adjustment parameter can be determined according to the vertex coordinates of the rectangular area of the human body contour, including: when it is determined that the rectangular area of the human body contour does not include a complete human body, determining a second direction of the position of the human body portion that is not captured relative to the video page. The embodiments of the present application can provide an implementation method, when it is determined that the rectangular area of the human body contour does not include a complete human body, in the process of determining the second direction of the position of the human body portion that is not captured relative to the video page, firstly a first size of the human body portion that is not captured can be calculated according to the vertex coordinates of the rectangular area of the human body contour, and the first size is a first width or a first length.

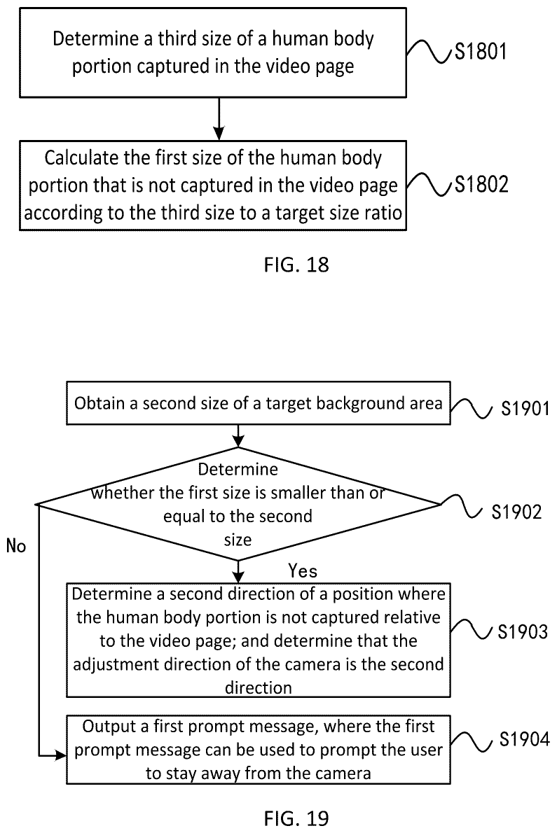

As shown in FIG. 18, FIG. 18 is a schematic diagram of a process of calculating a first size of a human body portion that is not captured according to some embodiments of the present application. Calculating the first size of a human body portion that is not captured includes the following steps S1801 to S1802.

S1801, determine a third size of a human body portion captured in the video page.

In some embodiments, the third size of the captured human body portion in the video page can be determined according to the vertex coordinates of the rectangular area of the human body contour: bodyPointA (left, top) and bodyPointB (right, bottom). The third size can be a third length or a third width.

As shown in the following formula (1):

$$pictureBodyHeight = bottom - top . \qquad ( 1 )$$

Formula (1) can represent the third length of the human body portion captured by the camera in the video page.

Or, the following formula (2):

$$pictureBodyWidth = right - left . \qquad ( 2 )$$

Formula (2) can represent the third width of the human body portion captured by the camera in the video page.

S1802: calculate the first size of the human body portion that is not captured in the video page according to the third size to a target size ratio.

The target size ratio is a size ratio of the human body portion that is not captured in the complete human body. For example, the limb key point data returned by the AI algorithm does not include the key point data of the lower limbs, indicating that the camera did not capture the user's lower limbs. Therefore, it is necessary to calculate the length of the lower limbs that is not captured according to the ratio of the length of the lower limbs to the height of the human body.

$$BodyHeight = \frac{pictureBodyHight}{1 - p 1} . \qquad ( 3 )$$

As shown in the following formula (3):

Formula (3) can represent the length of the actual height of the human body portion in the video page, where p1 is the length ratio of the human body portion that is not captured to the complete human body.

$$BodyWidth = \frac{pictureBodyWidth}{1 - p 2} . \qquad ( 4 )$$

Or, as in formula (4):

Formula (4) can represent the width of the actual height of the human body portion in the video page, where p2 is the width ratio of the human body portion that is not captured to the complete human body.

Furthermore, the first length of the human body portion not captured can be calculated according to formula (5):

$$nobodyHeight = BodyHeight * p 1. \qquad ( 5 )$$

Alternatively, the first width of the human body portion not captured can be calculated according to formula (6):

$$nobodyWidth = BodyWidth * p 2. \qquad ( 6 )$$

After calculating the first size of the human body portion that is not captured: the first length or the first width, as shown in FIG. 19, FIG. 19 is a second flow chart of another processing method for a display apparatus according to some embodiments of the present application, including the following steps S1901 to S1904.

S1901, obtain a second size of a target background area.

The target background area can be a background area in the video page in a direction opposite to a direction where the human body portion not captured is located.

The following formula (7) can calculate the second length of the target background area according to the vertex coordinates of the human body contour boundary area: bodyPointA (left, top) and bodyPointB (right, bottom), and the vertex coordinates of the preset effective control area: controlPointA (X1, Y1) and controlPointB (X2, Y2):

$$diffHight 1 = top - Y 1. \qquad ( 7 )$$

It indicates that the direction where the human body portion is not captured is the lower side in the video page, and the opposite direction is the upper side. The second length diffHight1 of the target background area on the upper side can be calculated according to formula (7).

Or the following formula (8):

$$diffHight 2 = Y 2 - bottom . \qquad ( 8 )$$

It indicates that the direction where the human body portion is not captured is the upper side in the video page, and the opposite direction is the lower side. The second length diffHight2 of the target background area at the lower side can be calculated according to formula (8).

Alternatively, the second width of the target background area can be calculated according to formula (9):

$$diffWidth 1 = X 1 - left . \qquad ( 9 )$$

It indicates that the direction where the human body portion is not captured is the right side of the video page, and the opposite direction is the left side. The second width diffWidth1 of the target background area on the left side can be calculated according to formula (9).

Or the following formula (10):

$$diffWidth 2 = right - X 2. \qquad ( 10 )$$

It indicates that the direction where the human body portion is not captured is the left side of the video page, and the opposite direction is the right side. The second width diffWidth2 of the target background area on the right side can be calculated according to formula (10).

S1902: determine whether the first size is smaller than or equal to the second size.

When the first size is less than or equal to the second size, that is, the first length nobodyHeight is less than the second length diffHight1, or the first length nobodyHeight is less than the second length diffHight1; or, the first width nobodyWidth is less than the second width diffWidth1, or the first width nobodyWidth is less than the second width diffWidth2, step S1203 can be executed. The first size is compared with which of the above-mentioned second sizes, which is determined by the limb key point data output by the AI algorithm. For example, the output limb key points do not include lower limb key point data, then the first size nobodyHeight can be compared with diffHight1, and other optional implementations are the same or similar to them, and this application will not elaborate on them here.

When the first size is larger than the second size, step S1904 can be executed.

S1903: determine a second direction of a position where the human body portion is not captured relative to the video page; and determine that the adjustment direction of the camera is the second direction.

When the first size is less than or equal to the second size, taking the first length being less than the second length as an example, the first length is less than or equal to the second length, indicating that the first length where the human body portion is not captured is less than the second length of the target background area, and the second direction is the direction where the human body portion is not captured. After adjusting the camera according to the second direction, the complete human body portion can be displayed.

For example, the limb key point data output by the AI algorithm can indicate that the human body portion that is not captured is the lower limbs, and the lower limbs are located at the bottom of the video page. When the length of the target background area, that is, the area above the user's head, is greater than the length of the lower limbs, the camera movement direction can be determined to be downward to display the user's lower limbs on the video page, thereby fully displaying the user's body part, which is conducive to the AI algorithm to obtain accurate calculation results and improve human-computer interaction performance.

S1904: output a first prompt message, where the first prompt message can be used to prompt the user to stay away from the camera.

When the first size is larger than the second size, it means that the height or width of the human body portion that is not captured is larger, and it is difficult to capture the target image containing the complete human body portion by simply adjusting the camera. Therefore, the first prompt message can be output to prompt the user to move away from the camera, so as to control the camera to capture the complete human body portion and display it in the effective control area preset in the video page.

In some embodiments, when it is determined that the human body contour area includes a complete human body, the size of the complete human body in the video page can be determined, such as the following formula (11):

$$q = \frac{pictureBodyHight}{controlHight} . \qquad ( 11 )$$

Among them, q can represent the size of the complete human body in the video page, which can be presented in the form of a percentage. pictureBodyHight can be calculated according to the above formula (1). When the complete human body is included in the human body contour area, it can represent the length of the complete human body.

$$controlHight = Y 2 - Y 1. \qquad ( 12 )$$

controlHight can indicate the length of the preset effective control area.

When the size of the complete human body in the video page is less than half the size of the video page, that is, when q is less than 0.5, it means that the complete human body occupies a small proportion in the video screen, which can be not conducive to the subsequent AI algorithm to recognize it. Therefore, the second prompt message can be output, and the second prompt message can be used to prompt the user to get closer to the camera.

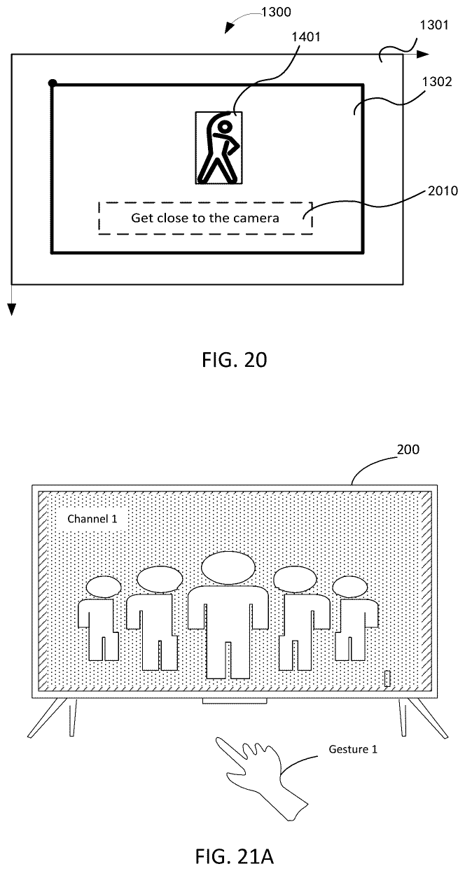

As shown in FIG. 20, FIG. 20 is a schematic diagram of the second prompt message according to some embodiments of the present application, showing: a video page 1300, a target image 1301, a preset effective control area 1302, a rectangular area of the human body contour 1401, and a second prompt message 2010. Thus, when the user's complete human body is displayed small in the video page, the user can be prompted to move closer to the camera so that the complete human body occupies a larger area on the video page, which can be conducive to the subsequent AI algorithm to accurately identify, thereby improving the human-computer interaction performance.

S1204: adjust a position of the camera according to the adjustment parameters.

After executing the above step S1203, the adjustment direction of the camera can be determined, or the adjustment direction and the adjustment angle can be determined, and then a position of the camera can be adjusted according to the adjustment direction; or, a position of the camera can be adjusted according to the adjustment direction and the adjustment angle.

In summary, the embodiments of the present application provide another processing method for a display apparatus, which can first control the camera to capture a target image and display a video page in the display, in which the target image can be displayed; then, the target image can be segmented to determine a rectangular area of the human body contour in the target image, and the vertex coordinates of the rectangular area of the human body contour in the video page can be obtained, and then the adjustment parameters of the camera can be determined according to the vertex coordinates of the rectangular area of the human body contour, so as to adjust a position of the camera according to the adjustment parameters. The display apparatus can therefore control the camera to capture a target image including a complete rectangular area of the human body contour, thereby achieving fast and accurate adjustment of a position of the camera and improving human-computer interaction performance.

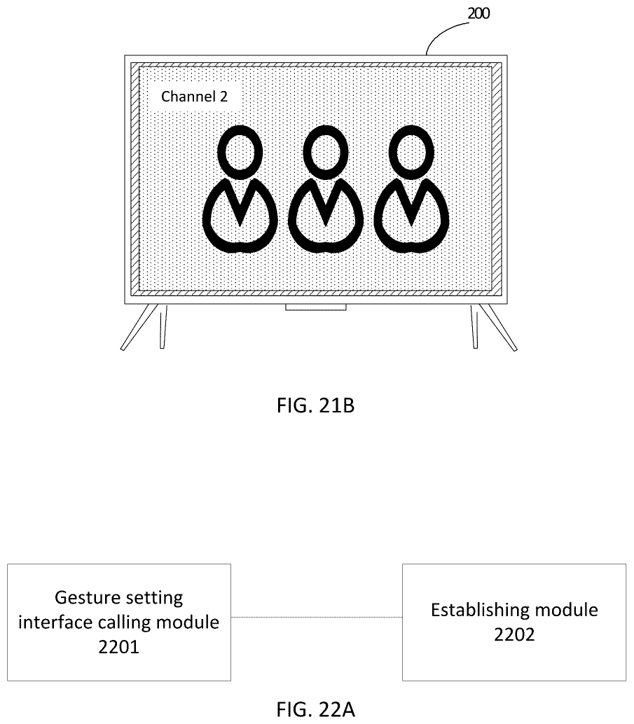

In the related art, when the display apparatus leaves the factory, gestures corresponding to different functional operations of the display apparatus can be pre-set, so that the user can use gestures to control the display apparatus to achieve different functional operations when using the display apparatus. Referring to FIG. 21A, when the user is watching channel 1, the display apparatus 200 can be pre-set with gesture 1 to achieve the function of switching channels when it leaves the factory. When the display apparatus 200 detects and recognizes gesture 1, it can perform the function of switching channels. Referring to FIG. 21B, it can switch from channel 1 to channel 2.

However, since the display apparatus can be pre-set with gestures corresponding to different functional operations of controlling the display apparatus when leaving the factory, users cannot set corresponding gestures for different functional operations according to their own preferences and habits. There are cases where the pre-set gestures are not suitable for users, or users are not clear about the functional operations corresponding to each gesture, resulting in a low utilization rate of users using gestures to control the display apparatus.

In order to solve the above problems, the embodiments of the present application provide a third processing method for a display apparatus. In the above technical solution, the display apparatus can call out a gesture setting interface according to a preset operation, where the gesture setting interface can be used to set a first correspondence between a target preset gesture and a preset function; in response to a target preset gesture input by a user in the gesture setting interface, and a preset function corresponding to the target preset gesture, a first correspondence between the target preset gesture and the preset function can be established and stored, so that when the display apparatus detects the target preset gesture, the preset function can be executed according to the first correspondence between the target preset gesture and the preset function. In the above technical solution, the gesture setting function can be started according to the preset operation, and the gesture setting interface can be called out, so that the user can set the corresponding target preset gesture for the preset function, and the first correspondence corresponding to the preset function can be established through the target preset gesture input by the user, so that the display apparatus can use the first correspondence to execute the preset function when the target preset gesture is detected, so as to meet the user's habits and preferences, thereby improving the user's utilization rate of using gestures to control the display apparatus to realize different functional operations and improving the user experience. In some embodiments, the above display apparatus can be a terminal device with a display function, such as a television, a mobile phone, a computer, a learning machine, etc. The display apparatus can include:
an output interface (display 260 and/or audio output interface 270) configured to output user interaction information;
a communicating device 220, configured to communicate with a server;
a memory, configured to store computer instructions and/or data associated with a display apparatus;
at least one processor 250, in connection with the output interface, the communicating device 220 and the memory, and further configured to execute the computer instructions to enable the display apparatus to:
call out a gesture setting interface according to a preset operation, where the gesture setting interface can be used to set a first correspondence relationship between a target preset gesture and a preset function;
in response to the target preset gesture input by the user in the gesture setting interface, and the preset function corresponding to the target preset gesture, establish and store the first correspondence relationship between the target preset gesture and the preset function, so that based on that the display apparatus detects the target preset gesture, the preset function can be executed according to the first correspondence relationship between the target preset gesture and the preset function.

In some embodiments, at least one processor 250 can be further configured to execute the computer instructions to enable the display apparatus to:
call out the gesture setting interface according to a number of times the preset function is used and a number of times the display apparatus is turned on; or
call out the gesture setting interface according to a detected first preset gesture; or
call out the gesture setting interface according to an activation gesture setting function.

In some embodiments, at least one processor 250 can be further configured to execute the computer instructions to enable the display apparatus to:
count a number of times the preset function is used and a number of times the display apparatus is turned on within a first time period;
calculate a first ratio of the number of times the preset function is used to the number of times the display apparatus is turned on, and based on that the first ratio is greater than a first preset threshold, call out the gesture setting interface.

In some embodiments, at least one processor 250 can be further configured to execute the computer instructions to enable the display apparatus to:
count a number of times a plurality of initial preset gestures are used and the number of times the display apparatus is turned on within the second time period;
calculate a second ratio of a number of times of each of the initial preset gestures is used to the number of times the display apparatus is turned on;
determine the target preset gesture from the plurality of initial preset gestures according to the second ratio corresponding to each of the initial preset gestures.

In some embodiments, at least one processor 250 can be further configured to execute the computer instructions to enable the display apparatus to:
compare the second ratio corresponding to each of the initial preset gestures with a second preset threshold; based on that the second ratio is less than the second preset threshold, determine that the initial preset gesture corresponding to the second ratio is the target preset gesture.

In some embodiments, at least one processor 250 can be further configured to execute the computer instructions to enable the display apparatus to:
compare the second ratios corresponding to the plurality of initial preset gestures; and
determine that the initial preset gesture corresponding to a smallest second ratio is the target preset gesture.

In some embodiments, at least one processor 250 can be further configured to execute the computer instructions to enable the display apparatus to:
obtain parameter information corresponding to the preset function;
establish and store a second correspondence relationship between the preset function and the parameter information; based on that the display apparatus detects the target preset gesture, execute the preset function according to the first correspondence relationship and the second correspondence relationship.

In summary, the present application can execute the above-mentioned processing method for display apparatus on a display apparatus, and call out a gesture setting interface according to a preset operation through at least one processor of the display apparatus, where the gesture setting interface can be used to set a first correspondence between a target preset gesture and a preset function; in response to a target preset gesture input by a user in the gesture setting interface, and a preset function corresponding to the target preset gesture, a first correspondence between the target preset gesture and the preset function can be established and stored, so that when the display apparatus detects the target preset gesture, the preset function can be executed according to the first correspondence between the target preset gesture and the preset function. In the above-mentioned technical scheme, the gesture setting function can be started according to the preset operation, and the gesture setting interface can be called out, so that the user can set the target preset gesture corresponding to the preset function, and the first correspondence corresponding to the preset function can be established through the target preset gesture input by the user, so that when the display apparatus detects the target preset gesture, the preset function can be executed using the first correspondence, so as to meet the user's habits and preferences, thereby improving the user's utilization rate of using gestures to control the display apparatus to realize different functional operations and improving the user experience.

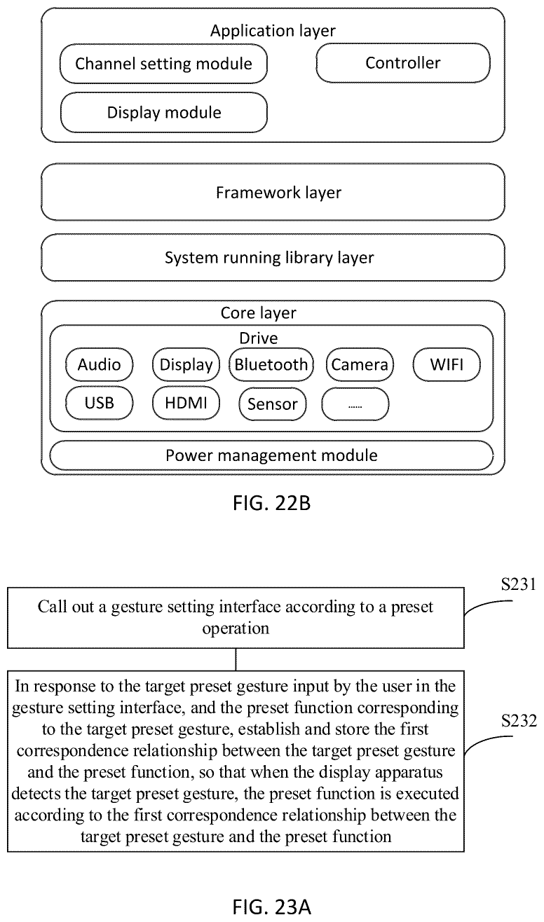

FIG. 22A is a framework diagram of a gesture setting system for a display apparatus according to one or more embodiments of the present application. As shown in FIG. 22A, the system can include a channel gesture setting interface calling module 2201 and an establishing module 2202. The system can use the gesture setting interface calling module 2201 to call out a gesture setting interface according to a preset operation, where the gesture setting interface can be used to set a first correspondence between a target preset gesture and a preset function, and the establishing module 2202 can be used to establish and store a first correspondence between the target preset gesture and the preset function in response to a target preset gesture input by a user in the gesture setting interface, and a preset function corresponding to the target preset gesture, so that when the display apparatus detects the target preset gesture, the preset function can be executed according to the first correspondence between the target preset gesture and the preset function. In the above technical scheme, the gesture setting function can be started according to the preset operation, and the gesture setting interface can be called out, so that the user can set the corresponding target preset gesture for the preset function, and establish a first correspondence corresponding to the preset function through the target preset gesture input by the user. When the display apparatus detects the target preset gesture, it can use the first correspondence to execute the preset function, thereby satisfying the user's habits and preferences, thereby increasing the user's usage rate of using gestures to control the display apparatus to achieve different functional operations and improving the user experience.

FIG. 22B is a gesture setting architecture diagram for a display apparatus according to one or more embodiments of the present application. According to the above system framework, the present application can be implemented as shown in FIG. 22B. The Android system can mainly include an application layer, a framework layer, a system runtime layer, and a kernel layer. The implementation logic can be mainly embodied in the application layer, including a channel first target area display module, a second target area display module, and a processing module. The functions of each module have been described in detail in the above embodiments. In order to avoid repetition, they will not be repeated here.

In the third processing method for a display apparatus provided in the embodiments of the present application, the display apparatus can first call out a gesture setting interface according to a preset operation, the gesture setting interface can be used to set a first correspondence between a target preset gesture and a preset function, and then in response to a target preset gesture input by a user in the gesture setting interface, and a preset function corresponding to the target preset gesture, can establish and store a first correspondence between the target preset gesture and the preset function, so that when the display apparatus detects the target preset gesture, the preset function can be executed according to the first correspondence between the target preset gesture and the preset function. In the above technical solution, the gesture setting function can be started according to the preset operation, and the gesture setting interface can be called out, so that the user can set the target preset gesture corresponding to the preset function, and the first correspondence corresponding to the preset function can be established through the target preset gesture input by the user, so that when the display apparatus detects the target preset gesture, the preset function can be executed using the first correspondence, so as to meet the user's habits and preferences, thereby improving the user's utilization rate of using gestures to control the display apparatus to realize different functional operations and improving the user experience.

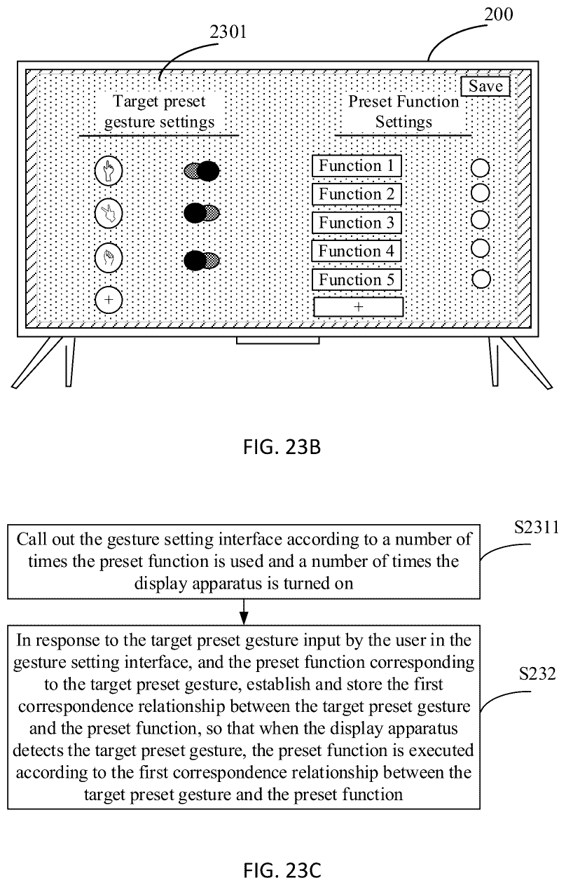

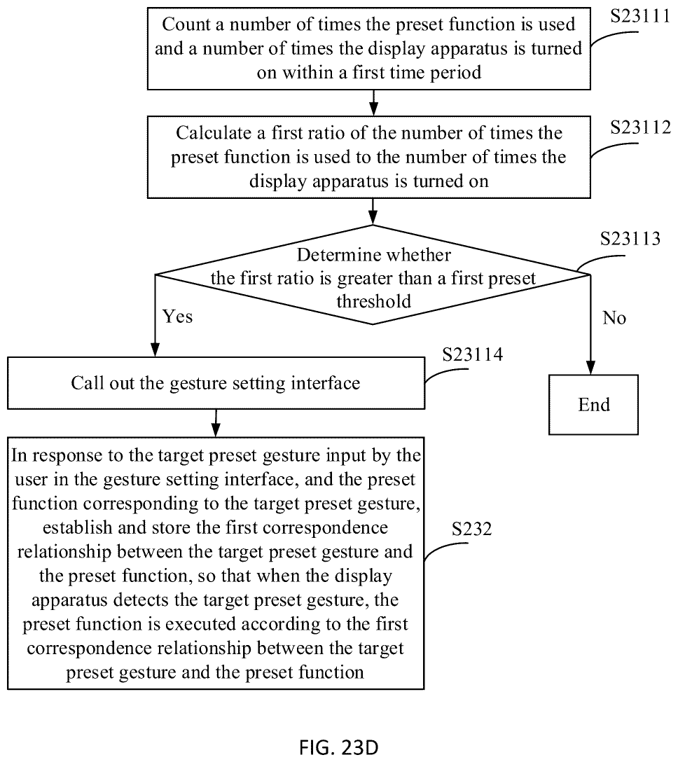

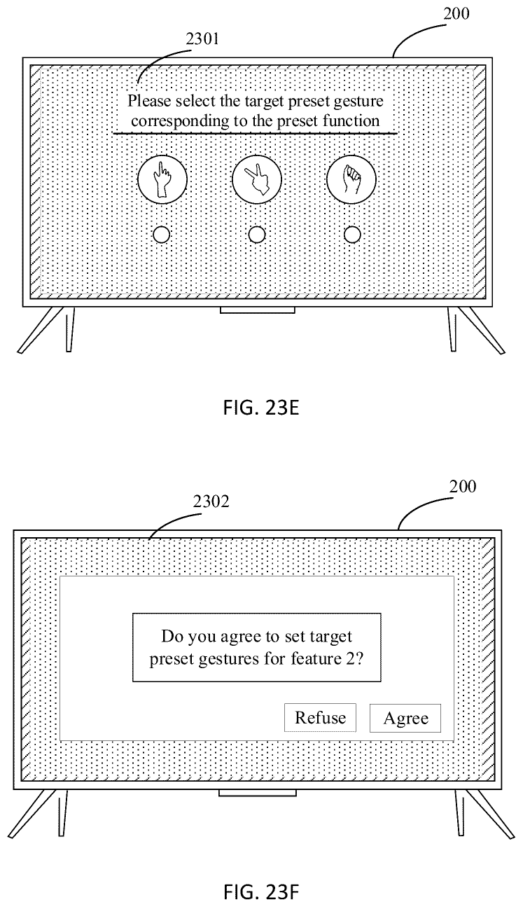

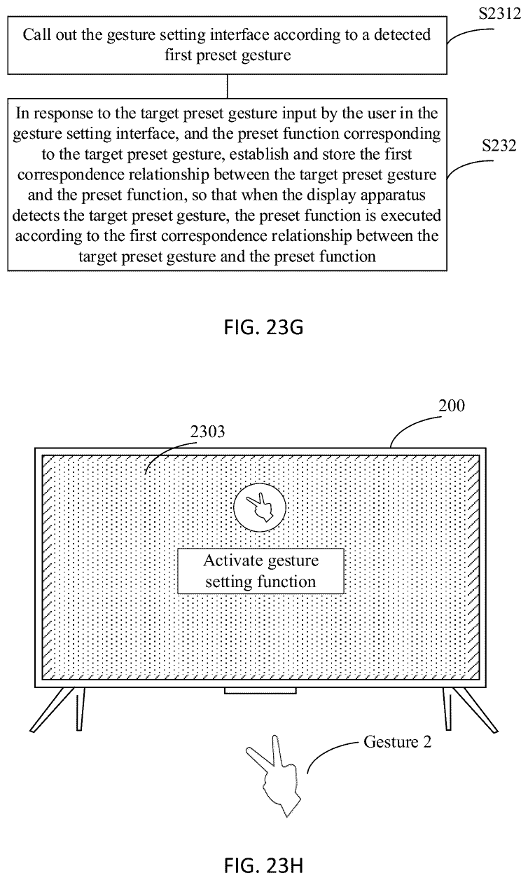

FIG. 23A is a first flow chart of a third processing method for a display apparatus according to some embodiments of the present application. As shown in FIG. 23A, the method can include the following steps.

S231, call out a gesture setting interface according to a preset operation.

Among them, the preset operation can refer to an operation that can start the gesture setting function and call out the gesture setting interface. For example, the preset operation can be an operation in which the user starts the setting gesture through a control device such as a remote control, but it is not limited to this, and the present application does not specifically limit it. The gesture setting interface can be used to set the first correspondence between the target preset gesture and the preset function. As shown in FIG. 23B, for the display apparatus 200, the target preset gesture and preset function can be set through the gesture setting interface 2301. But it is not limited to this, the present application does not specifically limit it, and technicians in this field can make specific settings according to actual conditions.

The above-mentioned preset function can refer to the function of controlling the display apparatus. The preset function can be an application function, such as a video play application function, an audio play application function, a web application function, etc. The preset function can also be a control function of the display apparatus, such as a channel switching function, a return to the home page function, a volume adjustment function, a display screen brightness adjustment function, etc., but is not limited to this. The present application does not specifically limit it, and technical personnel in this field can make specific settings according to actual conditions.

In some embodiments, the display apparatus can start the gesture setting function according to the preset operation, and call out a gesture setting interface for setting a first corresponding relationship between a target preset gesture and a preset function.

FIG. 23C is a second flow chart of a third processing method for a display apparatus according to some embodiments of the present application. FIG. 23C is a further description of a possible implementation of S231 according to the embodiments shown in FIG. 23A, as shown in FIG. 23C.

S2311, call out the gesture setting interface according to a number of times the preset function is used and a number of times the display apparatus is turned on.

Among them, the number of times the preset function is used and the number of times the display apparatus is turned on can be set up by setting a counter, and the counter can be used to count the number of times the preset function is used and the number of times the display apparatus is turned on. For preset functions such as a video play application function, when the video play application function is turned on, the counter can be increased by 1 to obtain the number of times the preset function is used, but not limited to this. The present application does not specifically limit it, and technical personnel in this field can make specific settings according to actual conditions.

In some embodiments, the display apparatus can count the number of times a preset function is used and the number of times the display apparatus is powered on, and according to the relationship between the number of times the preset function is used and the number of times the display apparatus is turned on, the gesture setting function can be started to call out the gesture setting interface.

FIG. 23D is a third flowchart diagram of a third processing method for a display apparatus according to some embodiments of the present application. FIG. 23D is a description of a possible implementation of S2311 according to the embodiments shown in FIG. 23C, as shown in FIG. 23D.

S23111, count a number of times the preset function is used and a number of times the display apparatus is turned on within a first time period.

Among them, the first time period can refer to a parameter used to limit the number of times a preset function is used and the number of times the display apparatus is turned on within a fixed time period. The first time period can be, for example, 30 days, but is not limited to this. The present application does not specifically limit it, and technical personnel in this field can set it according to actual conditions.

It should be noted that, for the first time period, it is assumed to be 30 days. The number of times the preset function is used and the number of times the display apparatus is turned on are counted from May 1, XXXX. When it comes to the 31st day, that is, May 31, the data on May 1 needs to be deleted. This is to ensure that the counted number of times the preset function is used and the number of times the display apparatus is turned on are the latest data and to further save memory.

In some embodiments, the display apparatus can count the number of times a preset function is used and the number of times the display apparatus is turned on within the first period of time.

Continuing with the above embodiments, for the first time period of 30 days, the preset function is the video play application function, then the number of times the video play application function is used within 30 days can be counted as N1, and the number of times the display apparatus is turned on can be N2, but not limited to this. The present application is not specifically limited, and technical personnel in this field can set it according to actual conditions.

S23112, calculate a first ratio of the number of times the preset function is used to the number of times the display apparatus is turned on.

In some embodiments, the display apparatus can calculate a ratio of the number of times the preset function is used and the number of times the display apparatus is turned on, and the calculation result is a first ratio.

Continuing with the above embodiments, the number of times the video play application function is used within 30 days can be counted as N1, and the number of times the display apparatus is turned on can be N2. The first ratio of the number of times the video play application function is used N1 to the number of times the display apparatus is turned on N2 can be calculated to be N1/N2=4, but not limited to this. The present application is not specifically limited, and technical personnel in this field can set it according to actual conditions.

S23113, determine whether the first ratio is greater than a first preset threshold.

Among them, the first preset threshold can be used to determine whether to start the gesture setting function to call out the parameters of the gesture setting interface. For example, the first preset threshold can be 3, but is not limited to this. The present application does not specifically limit it, and technical personnel in this field can set it according to actual conditions.

S23114, based on that the first ratio is greater than a first preset threshold, call out the gesture setting interface.

In some embodiments, the display apparatus can determine whether the first ratio is greater than a first preset threshold value, and when the first ratio is greater than the first preset threshold value, the gesture setting function can be started to call out the gesture setting interface.

Continuing with the above embodiments, referring to FIG. 23E, when the first ratio of the number of times the video play application function is used N1 to the number of times the display apparatus is turned on N2 is N1/N2=4, and the first preset threshold is 3, at this time, the first ratio 4 is greater than the first preset threshold 3, and the gesture setting function can be started to call out the gesture setting interface 2301. However, this is not limited to this, and the present application is not specifically limited, and those skilled in the art can set it according to actual conditions.

According to the above embodiments, in some embodiments of the present application, when it is determined that the first ratio is greater than a first preset threshold, a prompt message can be sent to the user to determine whether to set a target preset gesture for the preset function.

As shown in reference FIG. 23F, when it is determined that the first ratio is greater than the first preset threshold, an interface 2302 can be actively popped up in the display apparatus 200 to remind the user to determine whether to set the gesture. The interface can include “Do you agree to set a target preset gesture for function 2?” The user can use the virtual buttons “Reject” and “Agree” in the lower right corner of the interface to determine whether to agree to set the target preset gesture for function 2 according to user needs. When the user selects “Agree”, the target preset gesture can be set for function 2 and the gesture setting interface can be entered. When the user selects “Reject”, the target preset gesture is not set for function 2, but it is not limited to this. The present application does not specifically limit it, and technical personnel in this field can set it according to actual conditions.

In the technical solution provided by the embodiments of the present application, in the above process, by calculating the first ratio of the number of times the preset function is used and the number of times the display apparatus is turned on within a first time period, and comparing the first ratio with the first preset threshold, when it is determined that the first ratio is greater than the first preset threshold, it can be determined that the current preset function is a function frequently used by the user. At this time, the gesture setting function can be started, the gesture setting interface can be called out, and a target preset gesture can be set for the current preset function, so that the user can use the target preset gesture to directly control the preset function operation when using the display apparatus in the future, thereby improving the user experience.

FIG. 23G is a fourth flow chart of a third processing method for a display apparatus according to some embodiments of the present application. FIG. 23G is a further description of another possible implementation of S231 according to the embodiments shown in FIG. 23A, as shown in FIG. 23G.

S2312, call out the gesture setting interface according to a detected first preset gesture.

The first preset gesture can be used to control the display apparatus to start the gesture setting function. Referring to FIG. 23H, gesture 2 is the first preset gesture, but is not limited thereto. The present application does not specifically limit this, and those skilled in the art can set it according to actual conditions.

In some embodiments, the display apparatus can start a gesture setting function according to the detected first preset gesture and call out a gesture setting interface.

In some embodiments, when the display apparatus 200 detects gesture 2, the display apparatus 200 can start the gesture setting function and call out the gesture setting interface, but is not limited to this. The present application does not specifically limit it, and technicians in this field can set it according to actual conditions.

It should be noted that when a plurality of continuous images are captured by the built-in camera of the display apparatus and the first preset gesture is detected in the plurality of continuous images, the gesture setting function can be started and the gesture setting interface can be called out, so as to avoid the wrong start of the gesture setting function. However, it is not limited to this, and the present application is not specifically limited, and those skilled in the art can set it according to the actual situation.

FIG. 23I is a fifth flowchart diagram of a third processing method for a display apparatus according to some embodiments of the present application. FIG. 23I is a description of another possible implementation of S231 according to the embodiments shown in FIG. 23A, as shown in FIG. 231.

S2313, call out the gesture setting interface according to an operation for activating a gesture setting function.

Among them, the gesture setting function operation can refer to the operation of the user starting the gesture setting function through a control device such as a remote control display apparatus, but is not limited to this. The present application does not specifically limit it, and technical personnel in this field can set it according to actual conditions.

In some embodiments, when the display apparatus receives an operation from the user to start the gesture setting function, it can start the gesture setting function and call out the gesture setting interface.

In the technical solution provided by the embodiments of the present application, in the above process, the gesture setting function can be started and the gesture setting interface can be called out by calculating the relationship between the number of times the preset function is used and the number of times the display apparatus is turned on within the first time period, detecting the first preset gesture, or starting the gesture setting function operation. In this process, since the target preset gestures corresponding to different preset functions are set according to the user's habits and hobbies, the usage rate of using gestures to control the display apparatus to achieve different function operations when the user uses the display apparatus in the subsequent use is improved, thereby improving the user experience.

S232, in response to the target preset gesture input by the user in the gesture setting interface, and the preset function corresponding to the target preset gesture, establish and store the first correspondence relationship between the target preset gesture and the preset function, so that when the display apparatus detects the target preset gesture, the preset function is executed according to the first correspondence relationship between the target preset gesture and the preset function.

Among them, the corresponding relationship can refer to that for a preset function, when the user inputs a target preset gesture in the gesture setting interface, the preset function can be bonded to the target preset gesture, so as to determine that different target preset gestures can control the preset function corresponding to the display apparatus actuator.

In some embodiments, when the display apparatus receives a target preset gesture input by the user in the gesture setting interface, and a preset function corresponding to the target preset gesture, it responds to the target preset gesture and the preset function corresponding to the target preset gesture, can establish a first correspondence between the target preset gesture and the preset function corresponding to the target preset gesture, and store the first correspondence between the target preset gesture and the preset function, so that when the display apparatus detects the target preset gesture, it can execute the preset function according to the first correspondence between the target preset gesture and the preset function.

When the display apparatus detects a target preset gesture, the target preset gesture can be compared with multiple stored preset gestures. When it is determined that the target preset gesture exists in the multiple stored preset gestures, the preset function corresponding to the target preset gesture can be executed according to the stored first correspondence between the target preset gesture and the preset function, but not limited to this. The present application does not specifically limit it, and technical personnel in this field can set it according to actual conditions.

In the technical solution provided by the embodiments of the present application, the display apparatus can call out a gesture setting interface according to a preset operation, where the gesture setting interface can be used to set a first correspondence between a target preset gesture and a preset function; in response to a target preset gesture input by a user in the gesture setting interface, and a preset function corresponding to the target preset gesture, a first correspondence between the target preset gesture and the preset function can be established and stored, so that when the display apparatus detects the target preset gesture, the preset function can be executed according to the first correspondence between the target preset gesture and the preset function. In the above technical solution, the gesture setting function can be started according to the preset operation, and the gesture setting interface can be called out, so that the user can set the corresponding target preset gesture for the preset function, and the first correspondence corresponding to the preset function can be established through the target preset gesture input by the user, so that when the display apparatus detects the target preset gesture, the preset function can be executed using the first correspondence, so as to meet the user's habits and preferences, thereby improving the user's utilization rate of using gestures to control the display apparatus to realize different functional operations and improving the user experience.

According to the above embodiments, in some embodiments of the present application, the method can further include the following operations.

S61, count a number of times a plurality of initial preset gestures are used and the number of times the display apparatus is turned on within the second time period.

Among them, the second time period can refer to a parameter used to limit the number of times multiple initial preset gestures are used within a fixed time period, and the number of times the display apparatus is turned on. The second time period can be, for example, 30 days, but is not limited to this. The present application does not specifically limit it, and technical personnel in this field can set it according to actual conditions.

The above-mentioned multiple initial preset gestures can refer to the preset gestures that have been pre-set when the display apparatus leaves the factory, or preset gestures that the user has previously set according to their own habits and preferences, but are not limited to these. The present application is not specifically limited, and those skilled in the art can set them according to actual situations.

In some embodiments, the display apparatus can count the usage times corresponding to the multiple initial preset gestures and the power-on times of the display apparatus within the second time period.

Continuing with the above embodiments, for the second time period of 30 days, the multiple initial preset gestures are gesture 1, gesture 2, and gesture 3, then the number of uses of gesture 1, gesture 2, and gesture 3 within 30 days are counted as N3, N4, and N5 respectively, and the number of times the display apparatus is turned on is N2, but not limited to this. The present application is not specifically limited, and technical personnel in this field can set it according to actual conditions.

S62, calculate a second ratio of a number of times of each of the initial preset gestures is used to the number of times the display apparatus is turned on.

In some embodiments, the display apparatus can calculate a ratio between the number of times each initial preset gesture is used and the number of times the display apparatus is turned on, and the calculation result is a second ratio.

Continuing with the above embodiments, the number of times gesture 1, gesture 2, and gesture 3 are used within 30 days can be counted as N3, N4, and N5, the number of times the display apparatus is turned on can be N2, and the second ratio of the number of times gesture 1, gesture 2, and gesture 3 used N3, N4, and N5 to the number of times the display apparatus is turned on N2 is calculated respectively, but the present application is not limited to this, and technical personnel in this field can set it according to actual conditions.

S63: determine the target preset gesture from the plurality of initial preset gestures according to the second ratio corresponding to each of the initial preset gestures.

In some embodiments, the display apparatus can determines a target preset gesture from a plurality of initial preset gestures according to the calculated second ratios corresponding to the initial preset gestures.

According to the above embodiment, in some embodiments of the present application, further, a possible implementation manner of S63 can include the following operations.

S631, compare the second ratio corresponding to each of the initial preset gestures with a second preset threshold; when the second ratio is less than the second preset threshold, determine that the initial preset gesture corresponding to the second ratio is the target preset gesture.

Among them, the second preset threshold can be a parameter used to determine the target preset gesture among multiple initial preset gestures. For example, the second preset threshold can be 4, but is not limited to this. The present application does not specifically limit it, and technical personnel in this field can set it according to actual conditions.

In some embodiments, the display apparatus can determine in turn whether the second ratio corresponding to each initial preset gesture is greater than the second preset threshold. When there is a second ratio greater than the second preset threshold, the initial preset gesture corresponding to the second ratio currently greater than the second preset threshold can be used as the target preset gesture.

Following the above embodiments, when the second ratios of the number of times gesture 1, gesture 2, and gesture 3 are calculated to be N3, N4, and N5 and the number of times the display apparatus is turned on N2 are 5, 1, and 3 respectively, the second ratios corresponding to gesture 1, gesture 2, and gesture 3 are compared with the second preset threshold 2 in sequence, and when the second ratio 1 corresponding to gesture 2 is less than the second preset threshold 2, gesture 2 is determined to be the target preset gesture. However, this is not limited to this, and the present application is not specifically limited, and those skilled in the art can set it according to actual conditions.

According to the above embodiments, in some embodiments of the present application, another possible implementation of S63 can include the following operations.

S632: compare the second ratios corresponding to the plurality of initial preset gestures; and determine that the initial preset gesture corresponding to a smallest second ratio is the target preset gesture.

In some embodiments, the display apparatus can compare the second ratios corresponding to the multiple initial preset gestures, determine the smallest second ratio among the multiple second ratios, and use the initial preset gesture corresponding to the smallest second ratio as the target preset gesture.

Following the above embodiments, when the second ratios of the number of times gesture 1, gesture 2, and gesture 3 are calculated to be N3, N4, and N5 and the number of times the display apparatus is turned on N2 are 5, 1, and 3 respectively, the second ratios corresponding to gesture 1, gesture 2, and gesture 3 can be compared, and gesture 2 corresponding to the second ratio 1 can be determined to be the target preset gesture. However, this is not limited to this, and the present application is not specifically limited, and those skilled in the art can set it according to actual conditions.

In the technical solution provided by the embodiments of the present application, in the above process, by calculating the second ratio of the number of times multiple initial preset gestures are used and the number of times the display apparatus is turned on within a second time period, and according to the multiple second ratios, determining the target preset gesture from the multiple initial preset gestures, in this way, the preset functions of the infrequently used initial preset gestures in the pre-set initial preset gestures can be updated, without the user having to input a new preset gesture, thus saving memory.

According to the above embodiments, in some embodiments of the present application, when executing S232, the following step can be further included.

S2321, obtain parameter information corresponding to the preset function.

Among them, parameter information can refer to the parameter information corresponding to the current preset function when the current display apparatus is executing a preset function. For example, when the preset function is a video play application function, and the video play application function is playing a movie at this time, the play mode can be a movie mode, and the movie mode can include the frequency information of the display screen, audio information, etc., that is, when the current parameter information is the video play application function playing a movie, the movie mode can include the frequency information of the display screen, audio information, etc., but is not limited to this. The present application is not specifically limited, and technical personnel in this field can set it according to actual conditions.

In some embodiments, when determining to establish a target preset gesture for a preset function, the display apparatus can obtain parameter information corresponding to the preset function.

S2322, establish and store a second correspondence relationship between the preset function and the parameter information; when the display apparatus detects the target preset gesture, execute the preset function according to the first correspondence relationship and the second correspondence relationship.

In some embodiments, the display apparatus can obtain parameter information corresponding to the preset function, establish a second correspondence between the preset function and the parameter information corresponding to the preset function, and store the second correspondence established between the preset function and the parameter information corresponding to the preset function, so that when the display apparatus detects the target preset gesture, it can execute the preset function according to the first correspondence between the preset gesture and the preset function, and the second correspondence between the preset function and the parameter information corresponding to the preset function.

In the above-mentioned technical solution provided by the embodiments of the present application, in the above-mentioned process, not only is the corresponding target preset gesture suggested for the preset function, but also a second correspondence between the preset function and its corresponding parameter information can be established, so that when the display apparatus detects the target preset gesture, it can execute the preset function according to the first correspondence and the second correspondence, without the user having to further adjust the parameters, thereby facilitating user operation and improving user experience.

At present, gesture control can be widely used in display apparatuses (such as smart large-screen devices, etc.). In related technologies, gesture recognition can be performed on the obtained image to determine the control instruction corresponding to the gesture, and then control the display apparatus to perform the corresponding operation. In practical applications, when the display apparatus is performing gesture recognition, there are situations where other gestures suddenly break into the recognizable range of the display apparatus. At this time, the image obtained by the display apparatus can contain multiple gestures, and it is difficult for the display apparatus to accurately determine which gesture is the gesture for controlling the display apparatus, which can interfere with the control of the display apparatus and affect the accuracy of gesture recognition; in addition, users can inevitably shake when making gestures, which can enable the display apparatus to determine the wrong control instruction according to the shaking of the gesture. For example, when the user controls the play volume of the display apparatus through gestures, due to the small-range shaking of the gesture, the play volume of the display apparatus can fluctuate, affecting the user's experience.

In order to solve some or all of the above-mentioned technical problems, according to the display apparatus of some embodiments of the present application, a fourth processing method for a display apparatus can be provided, in which the display apparatus can first obtain a continuous first gesture image and a second gesture image through a camera, and then determine the gesture movement direction and gesture movement speed of changing from the first gesture image to the second gesture image according to the first gesture image and the second gesture image, further control the camera to obtain a third gesture image, and determine the coordinate range to be recognized in the third gesture image according to the gesture movement direction and the gesture movement speed, and then perform gesture recognition on the coordinate range to be recognized. When the gesture is identified to match a preset gesture, the control instruction of the preset gesture can be executed, so that the display apparatus can perform gesture recognition on the coordinate range to be recognized in a targeted manner, avoiding the interference of sudden gestures on the display apparatus, and improving the accuracy of gesture control of the display apparatus.

Still in the scene shown in FIG. 2, the user can make a corresponding gesture, and the display apparatus 200 can control the camera 201 to obtain a continuous first gesture image and a second gesture image, where both the first gesture image and the second gesture image contain the gesture made by the user; and then the first gesture image and the second gesture image can be subjected to preliminary gesture recognition, mainly used to determine the direction and speed of the gesture movement in the process of changing from the first gesture image to the second gesture image. Afterwards, the camera 201 can be controlled to capture images again to obtain a third gesture image, and the coordinate range to be recognized in which the gesture may appear in the third gesture image can be determined according to the aforementioned gesture movement direction and gesture movement speed, and then gesture recognition can be performed within the coordinate range to be recognized. If a gesture is identified, it is determined whether the identified gesture can match the preset gesture, and if so, the control instruction of the preset gesture can be executed.

By analyzing the gesture movement direction and gesture movement speed in two consecutive gesture images: the first gesture image and the second gesture image, the coordinate range to be recognized where the gesture may appear in the third gesture image at the next moment can be predicted, so as to perform gesture recognition in the coordinate range to be recognized, so as to avoid other gestures that suddenly appear in the third gesture image from interfering with the control of the display apparatus, thereby improving the accuracy of gesture control of the display apparatus.

According to a display apparatus of some embodiments of the present application, the display apparatus can include at least one processor 250, which can be further configured to execute computer instructions stored in a memory of the display apparatus to enable the display apparatus to:
control the camera to continuously obtain a first gesture image and a second gesture image;
determine a gesture movement direction and a gesture movement speed of changing from the first gesture image to the second gesture image according to the first gesture image and the second gesture image;
control the camera to obtain a third gesture image, and determine a coordinate range to be recognized in the third gesture image according to the gesture movement direction and the gesture movement speed;
perform gesture recognition on the coordinate range to be recognized, and based on that a preset gesture is matched, execute a control instruction of the preset gesture.

The above-mentioned display apparatus can analyze and predict the coordinate range of the gesture that can appear by identifying and recording the gesture coordinates, so as to identify the gesture that may appear in the coordinate range to be recognized, use the gesture as the control gesture, determine the control instruction of the preset gesture that matches the control gesture, so that the display apparatus can execute the operation corresponding to the control instruction, and realize gesture control of the display apparatus; gestures appearing in other areas outside this position are determined as interfering gestures and are not processed, thereby effectively preventing other gestures that suddenly intrude on the gesture recognition result during the gesture recognition process, thereby improving the accuracy and stability of gesture control of the display apparatus.

In some embodiments, for determining the gesture movement direction and the gesture movement speed of changing from the first gesture image to the second gesture image according to the first gesture image and the second gesture image, the at least one processor 250 can be further configured to execute the computer instructions to enable the display apparatus to:
perform gesture recognition on the first gesture image and the second gesture image to determine first gesture coordinates corresponding to the first gesture image and second gesture coordinates corresponding to the second gesture image;
determine a first time difference between the first gesture image and the second gesture image;
determine the gesture movement direction and the gesture movement speed according to the first time difference, the first gesture coordinates, and the second gesture coordinates.

In some embodiments, for performing gesture recognition on the first gesture image and the second gesture image to determine first gesture coordinates corresponding to the first gesture image and second gesture coordinates corresponding to the second gesture image, the at least one processor 250 can be further configured to execute the computer instructions to enable the display apparatus to:
perform gesture recognition on the first gesture image and the second gesture image to obtain a plurality of first candidate gestures and a plurality of second candidate gestures;
determine a first gesture from the plurality of first candidate gestures and a second gesture from the plurality of second candidate gestures according to similarities between the first candidate gestures and the first gesture image and similarities between the second candidate gestures and the second gesture image;
where the first gesture can be a gesture whose similarity is greater than or equal to a preset similarity among the plurality of first candidate gestures; the second gesture can be a gesture whose similarity is greater than or equal to the preset similarity among the plurality of second candidate gestures;
determine the first gesture coordinates corresponding to the first gesture and the second gesture coordinates corresponding to the second gesture.

In some embodiments, for determining the gesture movement direction and the gesture movement speed according to the first time difference, the first gesture coordinates, and the second gesture coordinates, the at least one processor 250 can be further configured to execute the computer instructions to enable the display apparatus to:
calculate a distance difference between the first gesture coordinates and the second gesture coordinates;
based on that the distance difference is greater than a preset distance threshold, determine the gesture movement direction and the gesture movement speed according to the first time difference and the distance difference.

In some embodiments, after calculating a distance difference between the first gesture coordinates and the second gesture coordinates, the at least one processor 250 can be further configured to execute the computer instructions to enable the display apparatus to:
based on that the distance difference is less than the preset distance threshold, determine a control instruction corresponding to the first gesture in the first gesture image to execute the control instruction corresponding to the first gesture to operate the display apparatus.

In some embodiments, for performing gesture recognition on the coordinate range to be recognized, and based on that the preset gesture is matched, executing the control instruction of the preset gesture, the at least one processor 250 can be further configured to execute the computer instructions to enable the display apparatus to:
perform gesture recognition on the coordinate range to be recognized; and based on that the preset gesture is matched and the gesture movement speed is greater than a preset threshold, execute the control instruction of the preset gesture.

In some embodiments, for performing gesture recognition on the coordinate range to be recognized, the at least one processor 250 can be further configured to execute the computer instructions to enable the display apparatus to:
crop the third gesture image to obtain a fourth gesture image according to the coordinate range to be recognized;
input the fourth gesture image into a gesture recognition model to obtain a gesture recognition result output by the gesture recognition model, wherein the gesture recognition result comprises: no gesture, gesture category, or gesture similarity.

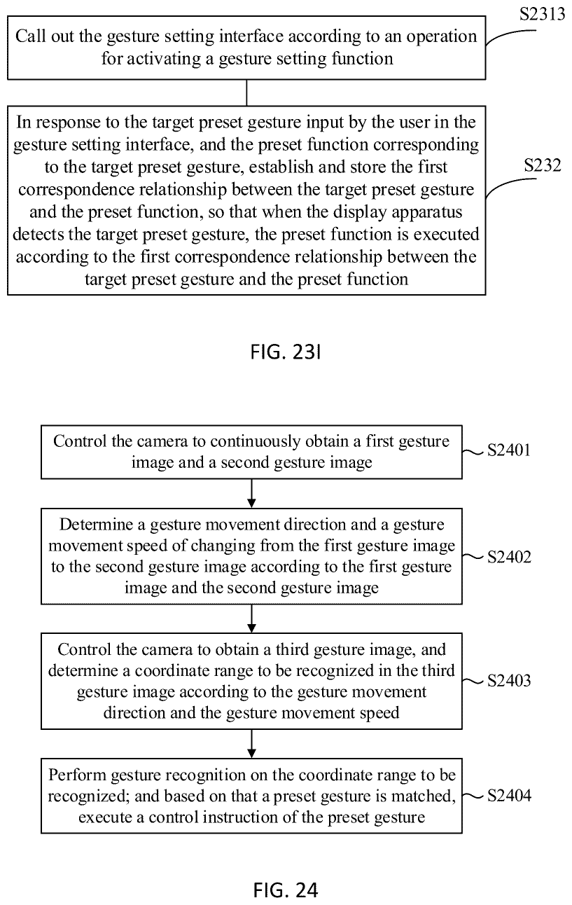

As shown in FIG. 24, FIG. 24 is a flowchart of a fourth processing method for a display apparatus according to some embodiments of the present application; the method can include the following steps S2401 to S2404.

S2401, control the camera to continuously obtain a first gesture image and a second gesture image.

In some embodiments, the display apparatus can obtain continuous first gesture images and second gesture images through a configured camera, where the camera can be a monocular camera, a binocular camera, an infrared camera, etc., and the present application does not impose any limitation on this.

It is understandable that the camera can capture images at a fixed acquisition frequency, and the time difference between multiple images captured by the camera can be fixed.

The first gesture image and the second gesture image are continuous, and a time difference between the first gesture image and the second gesture image can be a first time difference.

S2402: determine a gesture movement direction and a gesture movement speed of changing from the first gesture image to the second gesture image according to the first gesture image and the second gesture image.

In some embodiments, after acquiring the continuous first gesture image and the second gesture image, gesture recognition can be performed on the first gesture image and the second gesture image respectively. The process of gesture recognition can include: capturing images through cameras and millimeter waves, and then performing artificial intelligence calculations to calculate gestures in the images

In some embodiments, still referring to the software configuration diagram of the display apparatus shown in FIG. 5A, the display apparatus application layer can call the camera to capture images, obtain the first gesture image and the second gesture image, and then call the software development layer (Software Development Kit, SDK) interface to pass the first gesture image and the second gesture image to the SDK layer for artificial intelligence calculation. The SDK layer can perform image processing, image recognition and other operations on the first gesture image and the second gesture image to obtain the recognized gesture. The application layer can receive the gesture returned by the SDK layer, determine the first gesture coordinates of the first gesture in the first gesture image, and the second gesture coordinates of the second gesture in the second gesture image.

In some embodiments, the SDK layer can further obtain the category and similarity of the first gesture contained in the first gesture image, and the category and similarity of the second gesture contained in the second gesture image by recognizing the first gesture image and the second gesture image.

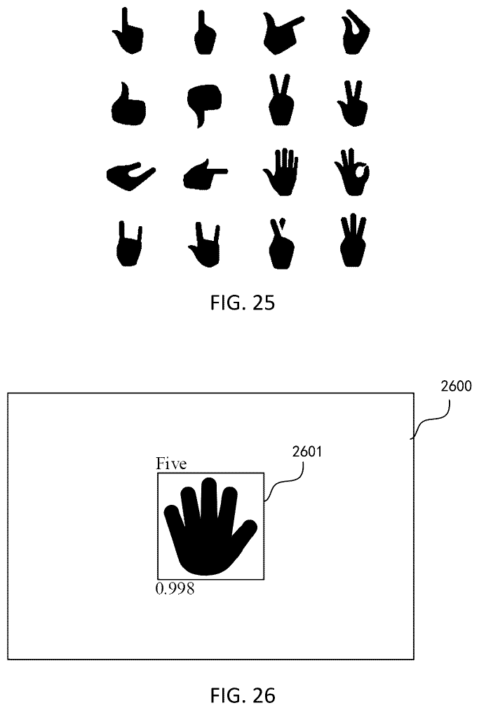

Among them, the similarity can refer to the similarity between the recognized gesture and the preset gesture. The preset gesture is shown in FIG. 25, which is a schematic diagram of the preset gesture according to some embodiments of the present application. The figure only exemplifies some preset gestures, and the present application does not limit them here.

In some embodiments, gesture recognition can be performed on the first gesture image and the second gesture image to obtain multiple first candidate gestures and multiple second candidate gestures. It can be understood that the gesture image captured by the camera can include multiple gestures of one user or multiple gestures of multiple users. Then, according to the similarity of each first candidate gesture, a candidate gesture with a similarity greater than a preset similarity can be determined from the multiple first candidate gestures as the first gesture corresponding to the first gesture image; according to the similarity of each second candidate gesture, a candidate gesture with a similarity greater than a preset similarity can be determined from the multiple second candidate gestures as the second gesture corresponding to the second gesture image. Among them, the preset similarity can be a pre-set similarity threshold used to screen valid gestures, which can be usually set to 0.8. Gestures with a similarity greater than or equal to 0.8 can be determined as valid gestures, and gestures with a similarity less than 0.8 can be determined as invalid gestures. After the first gesture and the second gesture are screened, the first gesture coordinates of the first gesture in the first gesture image can be determined, and the second gesture coordinates of the second gesture in the second gesture image can be determined.

The first gesture coordinates can be the coordinates of any one or more of the four vertices of the first gesture detection frame, or the coordinates of the center point of the first gesture detection frame, which is not limited in the present application. The second gesture coordinates can be the coordinates of any one or more of the four vertices of the second gesture detection frame, or the coordinates of the center point of the second gesture detection frame.

In some embodiments, the first gesture image can be identified to obtain the number of gestures handsCount, the gesture category handType, the similarity Score, and the gesture coordinates Rect included in the first gesture image. The gesture category handType can be gestures 1, 2, 3, fist, OK, etc. In the process of gesture recognition of the first gesture image, it is first determined whether the number of gestures recognized is zero. If not, it means that the first gesture image can contain gestures, and then the gesture category and similarity contained in the first gesture image can be identified.

As shown in FIG. 26, FIG. 26 is a schematic diagram of a first gesture image according to some embodiments of the present application. In the first gesture image, the first gesture coordinates can be connected or annotated to obtain a first gesture detection frame 2601. In some embodiments, the present application can control the display of the display apparatus to display the image captured by the camera in real time, and display the first gesture image 2600 annotated with the first gesture detection frame 2601 during gesture recognition of the first gesture image. The gesture category and similarity of the first gesture can be annotated on the first gesture detection frame 2601, such as the gesture category of the first gesture in FIG. 26 can be “Five” and the similarity can be 0.998.

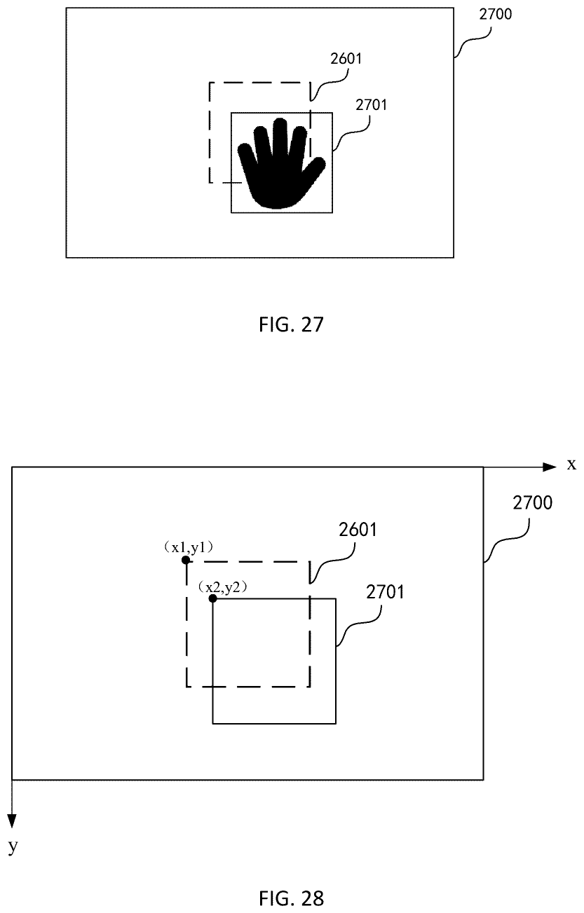

As shown in FIG. 27, FIG. 27 is a schematic diagram of a second gesture image according to some embodiments of the present application. At this time, the display apparatus can display the obtained second gesture image 2700, the first gesture detection frame 2601 and the second gesture detection frame 2701.

When the first gesture coordinates corresponding to the first gesture image and the second gesture coordinates corresponding to the second gesture image are obtained, the distance difference from the first gesture to the second gesture and the gesture movement direction from the first gesture to the second gesture can be first calculated, that is, the displacement change size and direction of the process from the first gesture coordinates to the second gesture coordinates can be calculated.

The embodiments of the present application provide an implementation method, which can calculate the distance difference and movement direction of the gesture in the horizontal coordinate direction according to the horizontal coordinate of the first gesture coordinate and the horizontal coordinate of the second gesture coordinate, and calculate the distance difference and movement direction of the gesture in the vertical coordinate direction according to the vertical coordinate of the first gesture coordinate and the vertical coordinate of the second gesture coordinate. As shown in FIG. 28, FIG. 28 is a schematic diagram of determining the gesture movement direction and gesture movement speed according to some embodiments of the present application. In the figure, for ease of explanation, the first gesture detection frame 2601 and the second gesture detection frame 2701 can be displayed in the same image, but those skilled in the art can understand that the actual situation is not necessarily the case. The first gesture detection frame shown in the image can be only used to illustrate the position of the first gesture, and does not mean that the first gesture actually appears at this position in the gesture image.

In FIG. 28, the first gesture coordinate A1 (x1, y1) and the second gesture coordinate A2 (x2, y2) can be used to calculate the distance difference of the gestures in the horizontal coordinate direction according to the following formula (1):

$$diffX = x 2 - x 1. \qquad ( 1 )$$

Among them, diff X greater than 0 can indicate that the gesture can move in the positive direction of the horizontal axis, and diff X less than 0 can indicate that the gesture can move in the negative direction of the horizontal axis.

The distance difference of the gesture in the vertical coordinate direction can be calculated according to the following formula (2):

$$diffY = y 2 - y 1. \qquad ( 2 )$$

Among them, diff Y greater than 0 can indicate that the gesture can move in the positive direction of the vertical axis, and diff Y less than 0 can indicate that the gesture can move in the negative direction of the vertical axis.

In some embodiments, a distance difference d between the first gesture coordinates and the second gesture coordinates can be calculated according to a Euclidean distance formula, and the gesture movement direction can be from the first gesture coordinates to the second gesture coordinates.

In some embodiments, after calculating the distance difference between the first gesture coordinates and the second gesture coordinates, it is determined whether the distance difference is greater than a preset distance threshold, which is a preset maximum distance for determining gesture jitter. When the distance difference is less than or equal to the preset distance threshold, it can indicate that the gesture has natural jitter, and then the first gesture can be matched with the preset gesture to determine the control instruction corresponding to the first gesture, so as to execute the control instruction corresponding to the first gesture to operate the display apparatus. The embodiments of the present application provide an implementation method, which can record the distance difference between the first gesture coordinates and the second gesture coordinates in a tabular form, so as to obtain other gesture coordinates later and calculate the distance difference between the second gesture coordinates and other gesture coordinates. If the aforementioned distance difference is less than or equal to the preset threshold, and the positive and negative values change alternately, it is determined that the gesture is jittery. The present application can ignore the distance difference between the gesture coordinates, and any gesture can be matched with the preset gesture to determine the corresponding control instruction to control the display apparatus to perform the corresponding operation.

The inventors have discovered that in the actual gesture recognition process, there is inevitably jitter when the user makes a gesture, resulting in a small displacement of the gestures recognized before and after. Current gesture recognition can recognize the displacement caused by gesture jitter as part of the user's gesture control. For example, when a user spreads out five fingers to select a certain media resource for play, the five-finger spread gesture jitters up and down, and the display apparatus can mistakenly recognize it as controlling the up and down page turning, affecting the user's experience.

In the above embodiments, by judging the distance difference of gesture movement and ignoring gesture changes where the distance difference is less than the preset distance threshold, it is possible to avoid misidentification caused by natural shaking of static gestures, accurately recognize the control instructions corresponding to gestures, and improve the accuracy of gesture control display devices.

When the distance difference between the first gesture coordinates and the second gesture coordinates is greater than the preset distance threshold, it means that the gesture made by the user has a large displacement relative to the display apparatus, rather than a natural shake. Then, according to the first time difference between the first gesture image and the second gesture image, and the distance difference d between the second gesture coordinates and the second gesture coordinates, the gesture movement speed corresponding to the change from the first gesture coordinates to the second gesture coordinates can be calculated.

In some embodiments, the first time difference between the first gesture image and the second gesture image is t1, and the gesture movement speed in the horizontal axis direction can be calculated according to the following formula (3):

$$Vx = \frac{diffX}{t 1} . \qquad ( 3 )$$

The gesture movement speed in the vertical axis direction can be calculated according to the following formula (4):

$$Vy = \frac{diffY}{t 1} . \qquad ( 4 )$$

S2403: control the camera to obtain a third gesture image, and determine a coordinate range to be recognized in the third gesture image according to the gesture movement direction and the gesture movement speed.

In some embodiments, after analyzing the previously captured first gesture image and second gesture image, it is determined that the gesture changes from the position corresponding to the first gesture coordinates to the position corresponding to the second gesture coordinates, and the gesture movement direction and gesture movement speed can be obtained, and then the camera can be controlled to obtain a third gesture image, and according to the second time difference between the third gesture image and the first gesture image, or the second time difference between the third gesture image and the second gesture image, and the gesture movement speed, a candidate coordinate range where the third gesture may appear in the third gesture image can be determined, and further, according to the gesture movement direction from the first gesture coordinates to the second gesture coordinates, a coordinate range to be recognized in the third gesture image can be determined to accurately perform gesture recognition on the coordinate range to be recognized.

In some embodiments, the second time difference between the third gesture image and the second gesture image is t2, the movement speed along the horizontal axis is Vx, and the candidate horizontal coordinate range is x2±Vx*t2; the movement speed along the vertical axis is Vy, and the candidate vertical coordinate range is y2±Vy*t2.

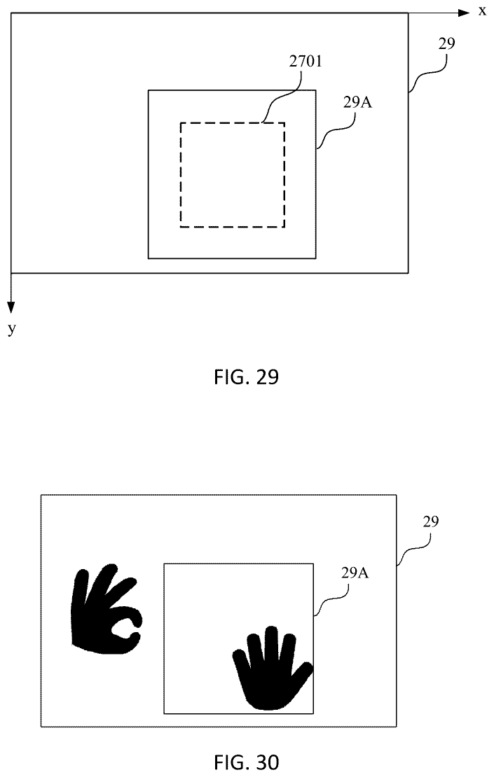

As shown in FIG. 29, FIG. 29 is a schematic diagram of a coordinate range to be recognized according to some embodiments of the present application, and the figure shows a third gesture image 29, a second gesture detection frame 2701, and a coordinate range to be identified 29A.

S2404: perform gesture recognition on the coordinate range to be recognized; and based on that a preset gesture is matched, execute a control instruction of the preset gesture.

The control instructions of the preset gestures include but are not limited to: mute, unmute, control volume, start/pause play, switch channels, power on/off, etc.

In the process of gesture recognition for the coordinate range to be recognized, the third gesture image can be cropped according to the coordinate range to be recognized to obtain a fourth gesture image. It can be understood that the size of the fourth gesture image is the same as the image size corresponding to the coordinate range to be recognized. Then, the fourth gesture image can be input into the gesture recognition model to obtain the gesture recognition result output by the gesture recognition model. The gesture recognition model can refer to the relevant technology and is not described in detail in the present application. The gesture recognition results can include: no gesture, gesture category, and gesture similarity.

When it is recognized that the third gesture image can include the third gesture, and the gesture category and gesture similarity of the third gesture can match a certain gesture in the preset gestures, the control instruction of the matched preset gesture can be determined and the control instruction of the preset gesture can be executed to realize accurate gesture recognition and control of the display apparatus by gesture when the user moves the gesture.

As shown in FIG. 30, FIG. 30 is a schematic diagram of the third gesture image according to some embodiments of the present application, the third gesture image 29 is shown in the figure, and gesture recognition can be performed on the coordinate range 29A to be identified in the third gesture image 29, and the five-finger open gesture can be identified, while the illustrated OK gesture exceeds the coordinate range 29A to be identified, and the OK gesture is not processed, and then the control instruction corresponding to the five-finger open gesture can be executed.

In the above-mentioned embodiments, by recognizing and recording gesture coordinates to analyze and predict the possible positions of gestures, and recognizing gestures that can appear at that position, the gesture can be used as a control gesture to determine the control instructions for the preset gesture that can match the control gesture, so that the display apparatus can execute the operation corresponding to the control instructions, achieving gesture control of the display apparatus. Gestures appearing in areas outside of this location are considered interference gestures and are not processed, effectively preventing interference from other sudden gestures during the gesture recognition process and improving the accuracy and stability of gesture control display apparatus.

In summary, some embodiments of the present application provide a fourth processing method for a display apparatus, the method can first control a camera to obtain continuous first gesture images and second gesture images, and then determine the gesture movement direction and gesture movement speed of changing from the first gesture image to the second gesture image according to the first gesture image and the second gesture image, and further control the camera to obtain a third gesture image and determine the coordinate range to be recognized in the third gesture image according to the gesture movement direction and the gesture movement speed, and then perform gesture recognition on the coordinate range to be recognized. When the gesture is identified to match a preset gesture, the control instruction of the preset gesture can be executed, so that the display apparatus can perform gesture recognition on the coordinate range to be recognized in a targeted manner, thereby avoiding interference of sudden gestures on the display apparatus, and improving the accuracy of gesture control of the display apparatus.

In recent years, with the rapid development of the Internet and the popularization of AI technology, display apparatuses such as smart TVs have gradually become smart terminals in people's daily lives, and they are also the first choice for living room entertainment. Especially during family gatherings, the large screen advantage of smart TVs will be highlighted, becoming the mainstream entertainment method for people.

With the continuous development of technology, the memory of display apparatuses is getting larger and larger. At the same time, more and more applications are installed in display apparatuses. Various resources and applications can occupy the available storage space of display apparatuses. Therefore, the problem of shooting failure can occur due to insufficient storage space of the display apparatus.

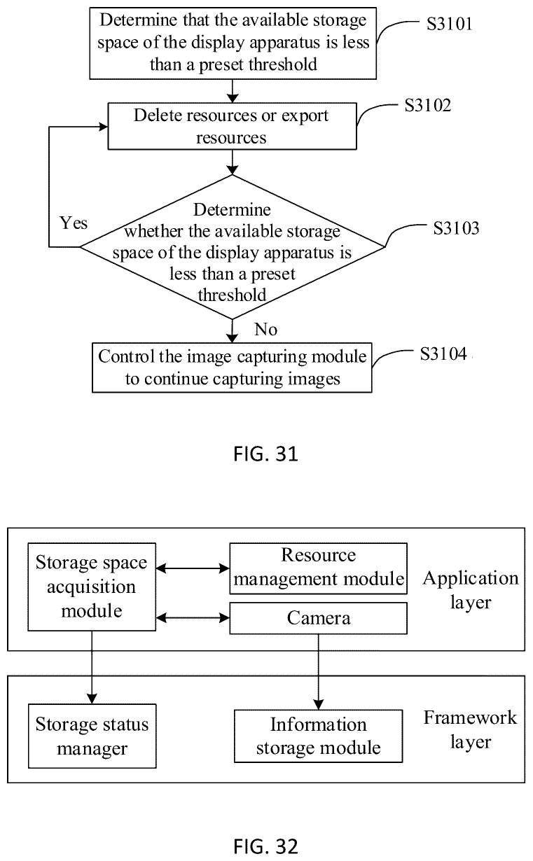

FIG. 31 is a flow chart of a processing method for a display apparatus in the related art. As shown in FIG. 31, the process can include the following steps.

S3101, the display apparatus determines that the available storage space of the display apparatus is less than a preset threshold.

The preset value can be a pre-set value, such as 200M, or 10% of the total storage space, etc. It may also be determined according to specific circumstances, and the embodiments do not make any specific limitation to this.

When the display apparatus determines that the available storage space of the display apparatus is less than a preset threshold, it can indicate that the available storage space of the display apparatus is insufficient.

S3102, the display apparatus deletes resources or exports resources.

When the display apparatus receives a resource deletion operation or resource export operation triggered by the user, the display apparatus can perform a deletion operation or an export operation on the resources selected by the user to increase the available storage space of the display apparatus.

S3103, determine whether the available storage space of the display apparatus is less than a preset threshold.

If so, S3102 can be executed; if not, S3104 can be executed.

S3104, control the image capturing module to continue capturing images.

In the above method, when the available storage space of the display apparatus is insufficient, the available storage space of the display apparatus can only be increased by deleting resources or exporting resources. If the user does not want to delete or export resources, the problem of shooting failure caused by insufficient storage space of the display apparatus cannot be solved. In addition, in the above method, few options are provided to users and cannot meet user needs.

In response to the above-mentioned problems, the present application can provide a fifth processing method for a display apparatus. In this method, when the display apparatus determines that the available storage space of the display apparatus is less than a preset threshold, the display can be controlled to display a prompt message, the prompt message can be used to prompt the user whether to turn on the memory saving mode. When an operation to turn on the memory saving mode is received, in response to the operation, the resolution of the camera is lowered from a first value to a second value, and the camera can be controlled to capture images at a resolution corresponding to the second value. In the above-mentioned technical solution, by lowering the resolution of the camera, the camera can capture images at the lowered resolution, thereby reducing the size of the captured image, which can save the available storage space of the display apparatus, enable the image capture device to capture more images, avoid the problem of shooting failure, and improve the user experience.

In some embodiments, the display apparatus can be a terminal device with display function and image acquisition function, such as a television, a mobile phone, a computer, etc. The at least one processor 250 in the display apparatus can be further configured to execute computer instructions stored in the memory of the display apparatus to enable the display apparatus to:
based on that an available storage space of the display apparatus is less than a preset threshold, control a display to display a prompt message, where the prompt message is used to prompt an user whether to turn on a memory saving mode;
in response to an operation of turning on the memory saving mode, lower a resolution of the camera from a first value to a second value;
control the camera to capture images at a resolution corresponding to the second value.

In some embodiments, at least one processor 250 is further configured to execute computer instructions to enable the display apparatus to:
in response to an operation of not turning on the memory saving mode, control the display to display target information of resource management, where the target information can include at least one of: deletion, export and deletion, export, or reducing image quality;
in response to an operation of determining a target option from the target information and an operation of determining a first resource from local resources of the display apparatus, perform an operation of the target option on the first resource to increase available storage space of the display apparatus;
control the camera to continue capturing images.

In some embodiments, the target option can include: the reducing image quality;
the at least one processor 250 can be further configured to execute the computer instructions to enable the display apparatus to:
in response to an operation of determining the reducing image quality from the target information and the operation of determining the first resource from the local resources of the display apparatus, lower a quality value of the first resource to obtain a second resource;
store the first resource and/or the second resource in a target apparatus;
perform a replacement operation on the first resource according to the second resource, and delete the first resource in the local resources to increase the available storage space of the display apparatus.

In some embodiments, the target option can include export and deletion;
the at least one processor 250 can be further configured to execute the computer instructions to enable the display apparatus to:
in response to an operation of determining the export and deletion from the target information and the operation of determining the first resource from the local resources of the display apparatus, store the first resource in the target apparatus and perform a deletion operation on the first resource to increase the available storage space of the display apparatus.

In some embodiments, before determining that the available storage space of the display apparatus is less than the preset threshold, the at least one processor 250 can be further configured to execute the computer instructions to enable the display apparatus to:
based on that the camera is detected to be activated, determine whether the memory saving mode is turned on;
based on that the memory saving mode is turned on, lower the resolution of the camera from the first value to the second value.

In some embodiments, the at least one processor can be further configured to execute the computer instructions to enable the display apparatus to:
obtain the available storage space of the display apparatus through a storage status manager of the display apparatus;
determine that the available storage space is smaller than the preset threshold according to a size relationship between the available storage space and the preset threshold.

In some embodiments, the aspect ratio of the first value can be equal to the aspect ratio of the second value.

In summary, the present application can execute the above-mentioned fifth processing method for a display apparatus on a display apparatus. When the display apparatus determines that the available storage space of the display apparatus is less than a preset threshold, the display can be controlled to display a prompt message, the prompt message can be used to prompt the user whether to turn on the memory saving mode. When an operation to turn on the memory saving mode is received, in response to the operation, the resolution of the camera can be lowered from a first value to a second value, and the camera can be controlled to capture images at a resolution corresponding to the second value. In the above-mentioned technical scheme, by lowering the resolution of the camera, the camera can capture images at the lowered resolution, thereby reducing the size of the captured image, which can save the available storage space of the display apparatus, enable the image capture device to capture more images, avoid the problem of shooting failure, and improve the user experience.

FIG. 32 is a system framework diagram of a fifth processing method for a display apparatus according to one or more embodiments of the present application. As shown in FIG. 32, in some embodiments, the software implementation of the method can mainly include two layers, namely, an application layer and a framework layer. The application layer can include a storage space acquisition module, a resource management module, and a camera; the framework layer can include a storage status manager and an information storage module. Specifically, the storage space acquisition module can be mainly used to record the current available storage space of the display apparatus, so that when the display apparatus determines that the available storage space is less than the preset threshold value according to the size relationship between the available storage space and the preset threshold value, the display of the display apparatus can be controlled to display a prompt message, and the prompt message can be used to remind the user; the resource management module can be mainly used to store and operate local resources, for example, it can perform operations such as deleting, replacing or exporting some resources to the target apparatus, and the target apparatus can be a USB flash drive, a server or a cloud, etc., and this embodiments do not specifically limit this. The camera can be mainly used for image capture, video recording, and parameter adjustment operations; the storage status manager (Storage Stats Manager) can be a storage space query and management function supported by the Android system. Through this part of the logic, the display apparatus can determine the current storage space usage of the entire machine; the information storage module can be as the camera function of the Andorid system, which can be mainly used to adjust the resolution and quality value, etc. At the same time, this part can store relevant information of the camera.

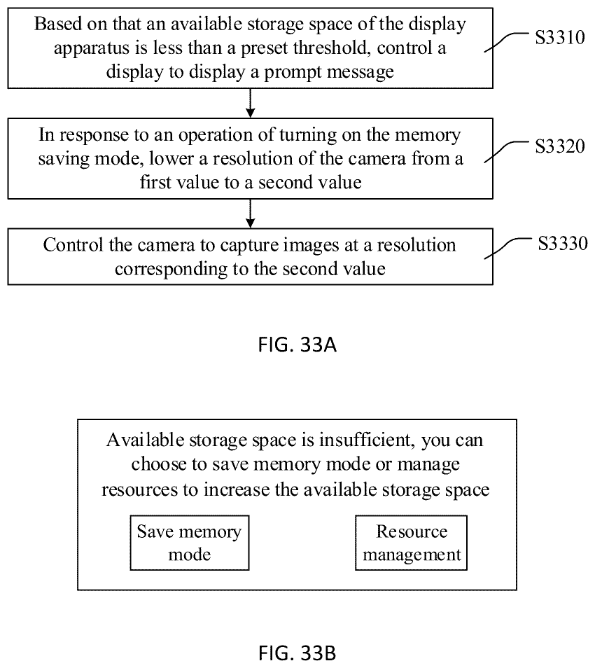

FIG. 33A is a flowchart of a fifth processing method for a display apparatus according to some embodiments of the present application. The embodiments can be used to illustrate the image acquisition process when the available storage space of the display apparatus is insufficient. As shown in FIG. 33A, the method specifically can include the following steps.

S3310: based on that an available storage space of the display apparatus is less than a preset threshold, control a display to display a prompt message.

The prompt message can be used to prompt the user whether to turn on the memory saving mode. The memory saving mode can be understood as a mode that reduces the size of the captured image by lowering the resolution of the camera, thereby avoiding shooting failure due to insufficient available storage space of the display apparatus. The display apparatus can be configured with a switch for the memory saving mode so that the user can turn on the memory saving mode.

In some embodiments, the display apparatus can obtain the usage of the storage space of the display apparatus. When it is determined according to the usage that the available storage space of the display apparatus is less than a preset threshold, it means that the available storage space of the display apparatus is insufficient, which can cause shooting failure. At this time, the display of the display apparatus can be controlled to display a prompt message, and the user can be prompted by the prompt message to allow the user to determine whether to turn on the memory saving mode.

S3320, in response to an operation of turning on the memory saving mode, lower a resolution of the camera from a first value to a second value.

Among them, the first value can be the resolution value supported by the camera, such as 1920*1080, or other values, which are not specifically limited in the embodiments. The second value can be the resolution value supported by the camera, such as 864*480, or other values, which are not specifically limited in the embodiments. The camera can usually support at least two resolution values. For example, the resolution values supported by a certain camera can be: 800*600, 864*480, 1024*576, 1680*896 and 1920*1080; the resolution value 1920*1080 has the highest resolution, and the resolution value 800*600 has the lowest resolution.

When the user performs an operation to turn on the memory saving mode through a smart device, a control device, or voice, the display apparatus, after receiving the operation, can respond to the operation and adjust the resolution of the camera from the first value to the second value. Specifically, the second value can be determined by at least one processor in the display apparatus, or can be set by the user, which is not limited in the embodiments.

In some embodiments, the aspect ratio of the first value can be equal to the aspect ratio of the second value.

In some embodiments, since the resolution is composed of width and height, when the aspect ratio of the first value is equal to the aspect ratio of the second value, it can be ensured that after the resolution is lowered, the captured image cannot be stretched or deformed, and no black edges can appear on the upper and lower sides or the left and right sides, which is conducive to improving the user experience and satisfaction.

In some embodiments, the second value can be set by a user, and therefore, the aspect ratio of the first value cannot be equal to the aspect ratio of the second value, which is not limited in the embodiments.

S3330, control the camera to capture images at a resolution corresponding to the second value.

After the display apparatus lowers the resolution of the camera from a first value to a second value, controlling the camera to capture images at a resolution corresponding to the second value can reduce the size of the image captured at this time, thereby reducing the storage space occupied by the image captured at this time, thereby ensuring normal use of the camera.

In some embodiments, when the first value is 1920*1080, when the resolution is used to capture an image of a certain scene, the size of the captured image is 511 KB, and when the second value is 864*480, when the resolution is used to capture an image of the same scene, the size of the captured image is 115 KB. From this, it can be seen that after lowering the resolution of the camera in the above manner, the image size can be reduced by 4 times. The effect is particularly significant when the file obtained when the image is captured at the resolution corresponding to the first value is large.

In the above method provided by the embodiments of the present application, when the display apparatus determines that the available storage space of the display apparatus is less than a preset threshold, the display can be controlled to display a prompt message, the prompt message can be used to prompt the user whether to turn on the memory saving mode. When an operation to turn on the memory saving mode is received, in response to the operation, the resolution of the camera can be lowered from a first value to a second value, and the camera can be controlled to capture images with a resolution corresponding to the second value. In the above technical solution, by lowering the resolution of the camera, the camera can capture images with the lowered resolution, thereby reducing the size of the captured image, which can save the available storage space of the display apparatus, enable the image capture device to capture more images, avoid the problem of shooting failure, and improve the user experience. This solution is particularly suitable for scenarios where users do not have high requirements for resolution.

FIG. 33B is a schematic diagram of an interface when a display displays a prompt message according to some embodiments of the present application. As shown in FIG. 33B, when the display apparatus determines that the available storage space of the display apparatus is less than a preset threshold, the display can be controlled to display a prompt message, which is: the available storage space is insufficient, you can choose to save memory mode or manage resources to increase the available storage space, and two options for the user to choose: save memory mode and resource management. Resource management means: the save memory mode is not turned on, which can be understood as managing the local resources of the display apparatus, thereby increasing the available storage space of the display apparatus.

In some embodiments, the above method can further include the following operations.

Before determining that the available storage space of the display apparatus is less than a preset threshold, detecting that the camera is started, and determining whether the memory saving mode is turned on.

When the memory saving mode is turned on, the resolution of the camera can be lowered from a first value to a second value.

In some embodiments, before determining that the available storage space of the display apparatus is less than a preset threshold, if the display apparatus detects that the camera is started, it can determine whether the memory saving mode is turned on. When the memory saving mode is turned on, the display apparatus can lower the resolution of the camera from the first value to the second value so that the camera can subsequently capture images at the resolution corresponding to the second value.

In some embodiments, based on that the available storage space of the display apparatus is relatively sufficient, if the memory saving mode is turned on, the display apparatus can lower the resolution of the camera from a first value to a second value, so that the camera can capture images at the resolution corresponding to the second value, thereby reducing the size of the captured image, saving storage space for the display apparatus, and allowing more resources to be stored in the display apparatus.

In some embodiments, based on that it is determined that the available storage space of the display apparatus is less than a preset threshold, controlling the display to display a prompt message can specifically include:
obtaining available storage space of the display apparatus through a storage status manager of the display apparatus;
based on that it is determined, according to the relationship between the available storage space and the preset threshold, that the available storage space is less than the preset threshold, controlling the display to display a prompt message.

In some embodiments, the storage status manager of the display apparatus has storage space query and management functions. Therefore, the display apparatus can obtain the current available storage space of the display apparatus through the storage status manager of the display apparatus, compare the size of the available storage space with a preset threshold, and control the display to display a prompt message when it is determined that the available storage space is less than the preset threshold according to the size relationship.

In some embodiments, through the above process, it can be determined that the available storage space of the display apparatus is less than the preset threshold, and prompt message can be provided in time to facilitate subsequent operations by the user.

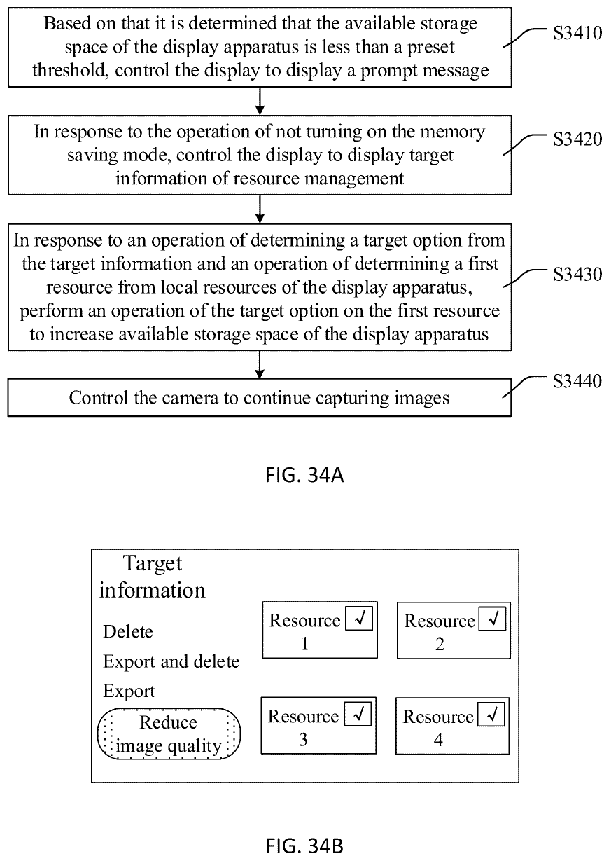

FIG. 34A is a flow chart of a fifth processing method for a display apparatus according to some embodiments of the present application. The embodiments can be optimized on the basis of the above embodiments. In some embodiments, the embodiments can be applied to illustrate the image acquisition process when the memory saving mode is not turned on. As shown in FIG. 34A, the method can specifically include the following steps.

S3410: based on that it is determined that the available storage space of the display apparatus is less than a preset threshold, control the display to display a prompt message.

S3420, in response to the operation of not turning on the memory saving mode, control the display to display target information of resource management.

The target information can include at least one option of deletion, export and deletion, export, and reduction of image quality.

In some embodiments, when the user does not turn on the memory saving mode, it means that the user has selected the resource management option in the prompt message. At this time, the display apparatus can control the display to display the target information of resource management in response to the operation of not turning on the memory saving mode. The target information can be used for the user to select, so that the subsequent display apparatus can perform the corresponding operation according to the user's selection.

S3430: in response to an operation of determining a target option from the target information and an operation of determining a first resource from local resources of the display apparatus, perform an operation of the target option on the first resource to increase available storage space of the display apparatus.

The target option can be understood as an option determined by the user from the options included in the target information. The local resource can be understood as a resource already stored in the display apparatus, which can be an image, video, etc., and the embodiments do not specifically limit this. The first resource can be understood as a resource to be edited determined by the user from the local resources of the display apparatus.

In some embodiments, when the user determines the target option from the options included in the target information of the resource management displayed on the display, and determines the first resource from the local resources of the display apparatus, the display apparatus can receive the user's operation of determining the target option from the target information and the user's operation of determining the first resource from the local resources of the display apparatus. In response to the operation of determining the target option from the user's target information and the user's operation of determining the first resource from the local resources of the display apparatus, the display apparatus can perform the operation of the target option on the first resource, thereby increasing the available storage space of the display apparatus, so that the subsequent camera can continue to capture images.

S3440, control the camera to continue capturing images.

In some embodiments, after the display apparatus performs the operation of the target option on the first resource, the available storage space can be increased. At this time, the camera can be controlled to continue to capture images so that the camera can shoot normally.

In some embodiments, the present application provides a fifth processing method for a display apparatus, when the display apparatus determines that the available storage space of the display apparatus is less than a preset threshold, the display can be controlled to display a prompt message; when an operation is received in which the memory saving mode is not turned on, that is, when an operation is received in which the user selects to manage resources, in response to the operation, the display can be controlled to display the target information of resource management; when an operation is received in which the user determines a target option from the target information and an operation is received in which the user determines a first resource from the local resources of the display apparatus, in response to the operation in which the target option can be determined from the target information and the operation in which the first resource can be determined from the local resources of the display apparatus, the target option operation can be performed on the first resource to increase the available storage space of the display apparatus. Finally, the camera can be controlled to continue to capture images. In the above technical scheme, by performing the target option operation on the first resource selected by the user, the available storage space of the display apparatus can be increased, so that the image capturing device can capture more images, avoid the problem of shooting failure, and improve the user experience. This scheme is particularly suitable for scenarios where users have high requirements for resolution, and can ensure that high-resolution images are captured and that the image capturing device can shoot normally.

FIG. 34B is a schematic diagram of an interface when a display shows target information of resource management according to some embodiments of the present application. As shown in FIG. 34B, the target information can mainly include four options: delete, export and delete, export, or reduce image quality. Resource 1, resource 2, resource 3, and resource 4 are the determined first resources. The display interface can indicate that the target option determined from the target information is to reduce image quality.

It should be noted that the options included in the target information in FIG. 34B, resource 1, resource 2, resource 3 and resource 4, can be only used to illustrate the embodiments and are not used to limit it.

In some embodiments, the target options include reducing image quality;
in response to an operation of determining a target option from target information and an operation of determining a first resource from local resources of a display apparatus, performing an operation of the target option on the first resource to increase available storage space of the display apparatus can specifically include:
in response to determining an operation of reducing the image quality from the target information and determining an operation of the first resource from the local resources of the display apparatus, lowering the quality value of the first resource to obtain a second resource;
storing the first resource and/or the second resource in the target apparatus, performing a replacement operation on the first resource according to the second resource, and deleting the first resource in the local resource to increase the available storage space of the display apparatus.

The target apparatus can be understood as a device with a storage function, such as a USB flash drive, a server, or a cloud, etc., and the embodiments do not specifically limit this.

In some embodiments, based on that the target option is to reduce the image quality, the display apparatus can respond to the user's operation of determining the image quality reduction from the target information and the operation of determining the first resource from the local resources of the display apparatus. Since the display apparatus can provide an entry for compressed resources (non-packaging compression), the quality (i.e., clarity) of the first resource can be reduced through the entry to obtain the second resource, thereby reducing the storage space occupied by the resource to obtain more storage space for the user. After obtaining the second resource, the display apparatus can store the first resource to the target apparatus, perform a replacement operation on the first resource according to the second resource, and delete the first resource in the local resources to increase the available storage space of the display apparatus. The display apparatus can also store the second resource to the target apparatus, perform a replacement operation on the first resource according to the second resource, and delete the first resource in the local resources to increase the available storage space of the display apparatus. The display apparatus can also store both the first resource and the second resource to the target apparatus, perform a replacement operation on the first resource according to the second resource, and delete the first resource in the local resources to increase the available storage space of the display apparatus.

In some embodiments, based on that reducing the image quality, the solution for reducing resource quality provided by the Android system can be used to obtain a bitmap corresponding to the first resource. The bitmap can support adjustment of the image quality. Specifically, any quality value from 0 to 100 can be selected, with 100 being the original image quality. The smaller the quality value, the worse the image clarity and the smaller the storage space occupied.

In some embodiments, the size of an original image (quality value is 100) is 1.02 MB. After the quality value of the image is lowered to 25, the size of the obtained image is 341 KB.

In some embodiments, by lowering the quality value of the first resource to obtain the second resource, retaining the second resource in the local resources of the display apparatus, and deleting the first resource, it can not only achieve the effect of retaining resources, but also save the available storage space of the display apparatus, so that the image capturing device can capture more images and avoid the problem of shooting failure.

In some embodiments, the target options can include export and deletion;
in response to an operation of determining a target option from target information and an operation of determining a first resource from local resources of a display apparatus, performing an operation of the target option on the first resource to increase available storage space of the display apparatus can specifically include:
in response to determining the export and deletion operation from the target information and determining the first resource from the local resources of the display apparatus, storing the first resource in the target apparatus and performing the deletion operation on the first resource to increase the available storage space of the display apparatus.

In some embodiments, based on that the target option is to export and delete, the display apparatus can respond to the user's operation of determining the export and deletion from the target information and the operation of determining the first resource from the local resources of the display apparatus, store the first resource to the target apparatus, and perform a deletion operation on the first resource, thereby increasing the available storage space of the display apparatus.

In some embodiments, by storing the first resource to the target apparatus and performing a deletion operation on the first resource, the first resource can be backed up and the available storage space of the display apparatus can be saved, so that the image capturing device can capture more images and avoid the problem of shooting failure.

In some embodiments, based on that the target option is to delete, the display apparatus performs a deletion operation on the first resource in response to the user determining the deletion operation from the target information and the operation of determining the first resource from the local resources of the display apparatus, thereby increasing the available storage space of the display apparatus, allowing the image capturing device to capture more images and avoiding the problem of shooting failure.

In some embodiments, based on that the target option is to export, the display apparatus can perform an export operation on the first resource in response to the user determining the export operation from the target information and the operation of determining the first resource from the local resources of the display apparatus. Specifically, the export can be to any storage device other than the display apparatus, thereby increasing the available storage space of the display apparatus, allowing the image capturing device to capture more images and avoiding the problem of shooting failure.

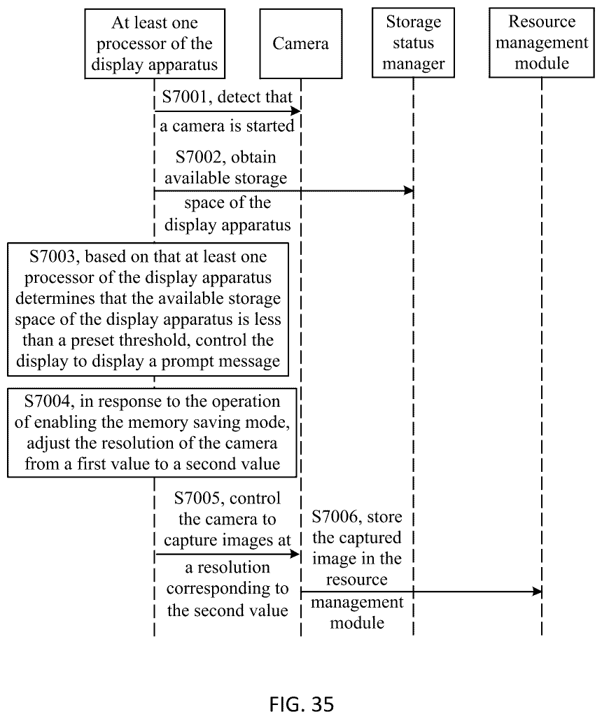

FIG. 35 is a schematic diagram of the interaction process between modules for implementing the fifth processing method for a display apparatus according to some embodiments of the present application. Specifically, the process can include the following steps.

S7001: at least one processor of a display apparatus can detect that a camera is started.

In some embodiments, at least one processor of the display apparatus can detect in real time whether the camera is started.

S7002: at least one processor of the display apparatus can obtain available storage space of the display apparatus.

At least one processor of the display apparatus can obtain available storage space of the display apparatus through the storage status manager.

S7003: based on that at least one processor of the display apparatus determines that the available storage space of the display apparatus is less than a preset threshold, the display apparatus can be controlled to display a prompt message.

Please refer to the specific description in S3310. In order to avoid repetition, it will not be repeated here.

S7004: in response to the operation of enabling the memory saving mode, at least one processor of the display apparatus can adjust the resolution of the camera from a first value to a second value.

Please refer to the specific description in S3320. In order to avoid repetition, it will not be repeated here.

S7005: at least one processor of the display apparatus can control the camera to capture images at a resolution corresponding to the second value.

Please refer to the specific description in S3330. In order to avoid repetition, it will not be repeated here.

S7006, the camera can store the captured image in the resource management module.

After the camera captures an image at a resolution corresponding to the second value, the captured image can be stored in the resource management module for subsequent viewing by users.

In some embodiments, through the above S7001-S7006, it mainly describes the situation after the user selects the memory saving mode option in the prompt message when the available storage space of the display apparatus is insufficient. This process is mainly suitable for scenarios where the user does not have high requirements for resolution. By reducing the size of the captured image, the available storage space of the display apparatus can be saved, so that the image capture device can capture more images and avoid the problem of shooting failure.

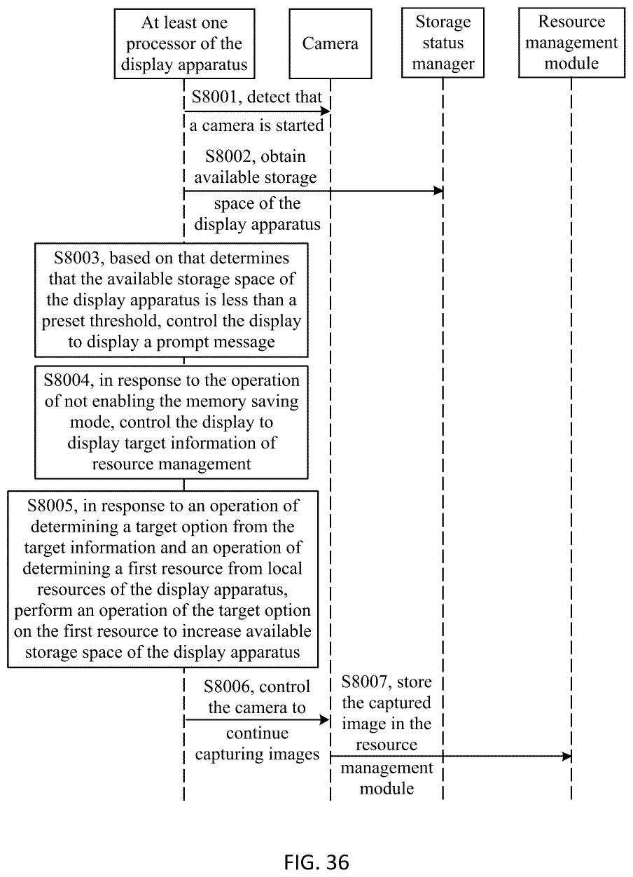

FIG. 36 is a schematic diagram of an interaction process between modules for implementing the fifth processing method for a display apparatus according to some embodiments of the present application. Specifically, the process can include the following steps.

S8001: at least one processor of a display apparatus can detect that a camera is started.

Please refer to the detailed description in S7001. To avoid repetition, it will not be repeated here.

S8002: at least one processor of the display apparatus can obtain available storage space of the display apparatus.

Please refer to the detailed description in S7002. To avoid repetition, it will not be repeated here.

S8003: based on that at least one processor of the display apparatus determines that the available storage space of the display apparatus is less than a preset threshold, the display apparatus can be controlled to display a prompt message.

Please refer to the specific description in S3310. In order to avoid repetition, it will not be repeated here.

S8004: in response to the operation of not enabling the memory saving mode, at least one processor of the display apparatus can control the display to display target information of resource management.

Please refer to the specific description in S3420. In order to avoid repetition, it will not be repeated here.

S8005: in response to an operation of determining a target option from the target information and an operation of determining a first resource from local resources of the display apparatus, at least one processor of the display apparatus can perform an operation of the target option on the first resource to increase available storage space of the display apparatus.

Please refer to the specific description in S3430. In order to avoid repetition, it will not be repeated here.

S8006: at least one processor of the display apparatus can control the camera to continue capturing images.

Please refer to the specific description in S3440. In order to avoid repetition, it will not be repeated here.

S8007, the camera can store the captured image in the resource management module.

After at least one processor of the display apparatus performs the operation of the target option on the first resource to increase the available storage space of the display apparatus, the camera can store the captured image to the resource management module for subsequent user viewing.

In some embodiments, the above S8001 to S8007 mainly describe the situation where the user selects the resource management option in the prompt message when the available storage space of the display device is insufficient. This process is mainly suitable for scenarios where the user has high requirements for resolution. By executing the target option operation on the first resource selected by the user, the available storage space of the display apparatus can be increased, which can ensure that high-resolution images are captured and the image capturing device can shoot normally, so that the image capturing device can capture more images and avoid the problem of shooting failure.

Some embodiments of the present application provide a computer-readable storage medium, on which a computer program can be stored. When the computer program is executed by a processor, it implements the various processes of the processing method for a display device in the above method embodiments, and can achieve the same technical effect. To avoid repetition, it will not be repeated here.

The computer-readable storage medium can be a read-only memory (ROM), a random access memory (RAM), a magnetic disk or an optical disk, etc.

The present embodiments provide a computing program product that can store a computer program. When the computer program is executed by a processor, it can implement the various processes of the processing method for display devices in the above method embodiments, and can achieve the same technical effect. To avoid repetition, it will not be repeated here.

Those skilled in the art will appreciate that the embodiments of the present application can be provided as methods, systems, or computer program products. Therefore, the present application may adopt the form of complete hardware embodiments, complete software embodiments, or some embodiments combining software and hardware. Moreover, the present application can adopt the form of a computer program product implemented on one or more computer-usable storage media that can include computer-usable program code.

In the present application, the processor can be a central processing unit (CPU), or other general-purpose processors, digital signal processors (DSP), application-specific integrated circuits (ASIC), field-programmable gate arrays (FPGA) or other programmable logic devices, discrete gate or transistor logic devices, discrete hardware components, etc. A general-purpose processor can be a microprocessor or the processor can also be any conventional processor, etc.

In the present application, the memory can include non-permanent memory in a computer-readable medium, random access memory (RAM) and/or non-volatile memory in the form of read-only memory (ROM) or flash RAM. Memory can be an example of a computer-readable medium.

In the present application, the computer-readable media can include permanent and non-permanent, removable and non-removable storage media. Storage media can be implemented by any method or technology to store information. The information can be computer-readable instructions, data structures, and modules of programs or other data. Examples of computer storage media include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, read-only compact disk read-only memory (CD-ROM), digital versatile disk (DVD) or other optical storage, magnetic cassettes, disk storage or other magnetic storage devices or any other non-transmission media that can be used to store information that can be accessed by a computing device. According to the definition in this article, computer-readable media does not include temporary computer-readable media (transitory media), such as modulated data signals and carrier waves.

For the convenience of explanation, the above description has been made in conjunction with specific embodiments. However, the above discussion in some embodiments is not intended to be exhaustive or limit the embodiments to the specific forms of the above applications. According to the above teachings, various modifications and variations can be obtained. The selection and description of the above embodiments are to better explain the principles and practical applications, so that those skilled in the art can better use the embodiments and various different variations of the embodiments suitable for specific use considerations.

What is claimed is:

1. A display apparatus, comprising:
a memory, configured to store computer instructions and/or data associated with the display apparatus;
at least one processor, in connection with the memory, wherein the at least one processor is configured to execute the computer instructions to enable the display apparatus to:
monitor a camera status broadcast message sent from a camera service in an operating system, wherein the camera status broadcast message is used to indicate whether a camera is activated by an application;
based on that the camera status broadcast message is a camera release message, call the camera to capture a camera image through a global application of the display apparatus,
wherein the camera release message is used to indicate that the camera is not activated by the application;
obtain human feature data from the camera image, and control the display apparatus to execute a corresponding function according to a control instruction corresponding to the human feature data.

2. The display apparatus according to claim 1, wherein before calling the camera to capture the camera image through the global application of the display apparatus based on that the camera status broadcast message is the camera release message, the at least one processor is further configured to execute the computer instructions to enable the display apparatus to:
based on that the camera status broadcast message is a camera activation message, control a display to display a camera activation icon on a current user interface to prompt an user that the camera is being activated by the application;
for calling the camera to capture the camera image through the global application of the display apparatus based on that the camera status broadcast message is the camera release message, the at least one processor is further configured to execute the computer instruction to enable the display apparatus to:
based on that the camera status broadcast message is the camera release message, control the display to remove the camera activation icon from the current user interface, and call the camera to capture the camera image through the global application of the display apparatus.

3. The display apparatus according to claim 1, wherein for obtaining human feature data from the camera image, the at least one processor is further configured to execute the computer instructions to enable the display apparatus to:
detect whether the camera image comprises valid human features, wherein the valid human features comprise: gesture features and/or human posture features;
based on that the camera image comprises the valid human features, obtain the human feature data from the camera image.

4. The display apparatus according to claim 3, wherein after detecting whether the camera image comprises the valid human features, the at least one processor is further configured to execute the computer instruction to enable the display apparatus to:
based on that the camera image does not comprise the valid human features, determine whether the camera is blocked;
based on that the camera is blocked, adjust a frequency at which the global application calls the camera from an initial frequency to a target frequency, and/or output a first prompt message;
wherein the target frequency is less than the initial frequency, and the first prompt message is used to prompt the user that the camera of the display apparatus is blocked.

5. The display apparatus according to claim 4, wherein for adjusting the frequency at which the global application calls the camera from the initial frequency to the target frequency, and/or outputting the first prompt message based on that the camera is blocked, the at least one processor is further configured to execute the computer instructions to enable the display apparatus to:
capture an image to be detected by the camera;
based on that a difference between a brightness value of the image to be detected and a minimum brightness value is less than or equal to a first preset value, adjust the frequency at which the global application calls the camera from the initial frequency to the target frequency, and/or output the first prompt message.

6. The display apparatus according to claim 5, wherein the brightness value is represented by an RGB value or a grayscale value; and/or,
the brightness value of the image to be detected comprises at least one of:
a brightness value of each pixel in the image to be detected;
a brightness value of each pixel in a partial area of the image to be detected;
an average brightness value of all pixels in the image to be detected; or
an average brightness value of pixels in a partial area of the image to be detected.

7. The display apparatus according to claim 4, wherein for adjusting the frequency at which the global application calls the camera from the initial frequency to the target frequency, and/or outputting the first prompt message based on that the camera is blocked, the at least one processor is further configured to execute the computer instructions to enable the display apparatus to:
capture an image to be detected by the camera;
determine at least one horizontal detection area and at least one vertical detection area in the image to be detected;
based on that differences between brightness values of any pixels in a target direction in a target detection area are less than or equal to a second preset value, adjust the frequency at which the global application calls the camera from the initial frequency to the target frequency, and/or output the first prompt message;
wherein the target detection area is a horizontal detection area, and the target direction is a vertical direction; or the target detection area is a vertical detection area, and the target direction is a horizontal direction.

8. The display apparatus according to claim 1, wherein the at least one processor is further configured to execute the computer instructions to enable the display apparatus to:
control the camera to capture a target image, and display a video page on a display, wherein the target image is displayed on the video page;
perform human body image segmentation on the target image to determine a rectangular area of a human body contour, and obtain vertex coordinates of the rectangular area of the human body contour in the video page;
determine an adjustment parameter according to the vertex coordinates of the rectangular area of the human body contour;
adjust a position of the camera according to the adjustment parameter.

9. The display apparatus according to claim 8, wherein before determining the adjustment parameter according to the vertex coordinates of the rectangular area of the human body contour, the at least one processor is further configured to execute the computer instructions to enable the display apparatus to:
obtain vertex coordinates of a preset effective control area in the video page;
wherein for determining the adjustment parameter according to the vertex coordinates of the rectangular area of the human body contour, the at least one processor is further configured to execute the computer instructions to enable the display apparatus to:
determine the adjustment parameter according to the vertex coordinates of the rectangular area of the human body contour and the vertex coordinates of the preset effective control area in the video page.

10. The display apparatus according to claim 9, wherein for determining the adjustment parameter according to the vertex coordinates of the rectangular area of the human body contour and the vertex coordinates of the preset effective control area in the video page, the at least one processor is further configured to execute the computer instructions to enable the display apparatus to:
determine whether the rectangular area of the human body contour overlaps with a margin area in the video page according to the vertex coordinates of the rectangular area of the human body contour and the vertex coordinates of the preset effective control area in the video page; wherein the margin area is an area in the video page excluding the preset effective control area;
based on that the rectangular area of the human body contour overlaps with the margin area in the video page, determine positional information of an overlapping area in the video page;
determine the adjustment parameter according to the positional information of the overlapping area in the video page.

11. The display apparatus according to claim 10, wherein the adjustment parameter is an adjustment direction, for determining the adjustment parameter according to the positional information of the overlapping area in the video page, the at least one processor is further configured to execute the computer instructions to enable the display apparatus to:
based on that the overlapping area is in a first direction in the video page, the adjustment direction of the camera is determined to be the first direction.

12. The display apparatus according to claim 8, wherein the adjustment parameter is an adjustment direction, for determining the adjustment parameter according to the vertex coordinates of the rectangular area of the human body contour, the at least one processor is further configured to execute the computer instructions to enable the display apparatus to:
based on that the rectangular area of the human body contour does not comprise a complete human body, determine a second direction of a position where a human body portion is not captured relative to the video page;
determine that the adjustment direction of the camera is the second direction.

13. The display apparatus according to claim 8, wherein the at least one processor is further configured to execute the computer instructions to enable the display apparatus to:
based on that the rectangular area of the human body contour does not comprise a complete human body, calculate a first size of a human body portion that is not captured according to the vertex coordinates of the rectangular area of the human body contour;
obtain a second size of a target background area, wherein the target background area is a background area in the video page in a direction opposite to a direction where the human body portion not captured is located;
based on that the first size is less than or equal to the second size, determine a second direction of a position where the human body portion is not captured relative to the video page; and determine that an adjustment direction of the camera is the second direction;
based on that the first size is larger than the second size, output a first prompt message, wherein the first prompt message is used to prompt the user to stay away from the camera;
wherein the first size is a first width, and the second size is a second width; or the first size is a first length, and the second size is a second length.

14. The display apparatus according to claim 13, wherein for calculating a first size of a human body portion that is not captured according to the vertex coordinates of the rectangular area of the human body contour, the at least one processor is further configured to execute the computer instructions to enable the display apparatus to:
determine a third size of a human body portion captured in the video page;
calculate the first size of the human body portion that is not captured in the video page according to the third size to a target size ratio;
wherein the target size ratio is a size ratio of the human body portion that is not captured in the complete human body.

15. The display apparatus according to claim 12, wherein the at least one processor is further configured to execute the computer instructions to enable the display apparatus to:
based on that the rectangular area of the human body contour comprises the complete human body, determine a size of the complete human body in the video page;
based on that the size of the complete human body in the video page is smaller than half of a size of the video page, output a second prompt message; wherein the second prompt message is used to prompt the user to get closer to the camera.

16. The display apparatus according to claim 1, wherein the at least one processor is further configured to execute the computer instructions to enable the display apparatus to:
call out a gesture setting interface according to a preset operation, wherein the gesture setting interface is used to set a first correspondence relationship between a target preset gesture and a preset function;
in response to the target preset gesture input by the user in the gesture setting interface, and the preset function corresponding to the target preset gesture, establish and store the first correspondence relationship between the target preset gesture and the preset function, so that based on that the display apparatus detects the target preset gesture, the preset function is executed according to the first correspondence relationship between the target preset gesture and the preset function.

17. The display apparatus according to claim 16, wherein the at least one processor is further configured to execute the computer instructions to enable the display apparatus to:
call out the gesture setting interface according to a number of times the preset function is used and a number of times the display apparatus is turned on; or
call out the gesture setting interface according to a detected first preset gesture; or
call out the gesture setting interface according to an operation for activating a gesture setting function.

18. The display apparatus according to claim 17, wherein the at least one processor is further configured to execute the computer instructions to enable the display apparatus to:
count a number of times the preset function is used and a number of times the display apparatus is turned on within a first time period;
calculate a first ratio of the number of times the preset function is used to the number of times the display apparatus is turned on, and based on that the first ratio is greater than a first preset threshold, call out the gesture setting interface.

19. The display apparatus according to claim 16, wherein the at least one processor is further configured to execute the computer instructions to enable the display apparatus to:
count a number of times a plurality of initial preset gestures are used and a number of times the display apparatus is turned on within a second time period;
calculate a second ratio of a number of times of each of the initial preset gestures is used to the number of times the display apparatus is turned on;
determine the target preset gesture from the plurality of initial preset gestures according to the second ratio corresponding to each of the initial preset gestures.

20. The display apparatus according to claim 19, wherein the at least one processor is further configured to execute the computer instructions to enable the display apparatus to:
compare the second ratio corresponding to each of the initial preset gestures with a second preset threshold;
based on that the second ratio is less than the second preset threshold, determine that the initial preset gesture corresponding to the second ratio is the target preset gesture.
